(19) United States
(12) Patent Application Publication
(10) Pub. No.: US 2003/0126464 A1
(43) Pub. Date: Jul. 3, 2003

(54) Method and system for determining and enforcing security policy in a communication session

(76) Inventors: Patrick D. McDaniel, Chatham, NJ (US); Atul Prakash, Ann Arbor, MI (US)

Correspondence Address: BROOKS & KUSHMAN, 1000 TOWN CENTER 22ND FL, SOUTHFIELD, MI, 48075

(21) Appl. No.: 10/006,552

(22) Filed: Dec. 4, 2001

(51) Int. Cl. G06F 11/30

(52) U.S. Cl. 713/201; 713/153; 380/277

(57) ABSTRACT

A method and system for determining and enforcing security policy in a communication session are provided in distributed systems. Policy encompasses the provisioning, authorization, and access control within the protected environment. Hence, all communication security requirements are explicitly stated through policy. A policy instantiation is constructed at run-time through policy determination. Conditional, abstract, and discretionary policies stated by communication participants are reconciled to arrive at an instantiation. The resulting instantiation is a concrete specification of the mechanisms, configurations, and access control model to be implemented by the session. The semantics of an instantiation are achieved through policy enforcement. The policy enforcement architecture implements session policies through the composition and configuration of security mechanisms using a novel event-bus architecture. Policy is enforced through the observation of and reaction to relevant events. The method and system of the invention diverges from past subscription-based event architectures by introducing additional infrastructure allowing significant implementation flexibility, robustness, and efficiency.

### STATEMENT REGARDING FEDERALLY SPONSORED RESEARCH OR DEVELOPMENT

This invention was made with Government support under Contract No. F 30602-00-2-0508 awarded by DARPA. The Government has certain rights in the invention.

### BACKGROUND OF THE INVENTION

1. Field of the Invention

This invention relates to methods and systems for determining and enforcing securing policy in a communication session for a group of participants.

2. Background Art

Group communication is increasingly used as an efficient building block for distributed systems. However, the cost and complexity of providing properties such as reliability, survivability, and security within a group is significantly higher than in peer communication. These costs are due to the additional number of failure modes, heterogeneity of the group members, and the increased vulnerability to compromise. Because of these factors, it is important to identify precisely the properties appropriate for a particular session.

The properties required by a session are defined through a group policy. Policy may be stated either explicitly through a policy specification or implicitly by an implementation. Contemporary group communication platforms operate from a largely fixed set of policies. These implicitly defined policies represent the threat and trust models appropriate for a set of target environments. However, an application and session whose security requirements are not directly addressed by the framework must implement additional infrastructure or modify their security model. Thus, these applications would benefit from frameworks allowing the explicit definition, distribution, and subsequent enforcement of security policies appropriate for the runtime environment.

Policy has been used in different contexts as a vehicle for representing authorization and access control, peer session security, quality of service guarantees, and network configuration. These approaches define a policy language or schema appropriate for their target problem domain.

Recent systems have adopted a more flexible domain of security policy. For example, the security policy system provides interfaces for the flexible definition of security policies for IPSec connections. These policies specify precisely the kinds of security mechanisms to be applied to peer session. Similarly, the GSAKMP protocol defines a policy token defining the specifics of a group session. The policy token is an exhaustive data structure (containing over 150 fields) stating precisely the kinds of security for a given group session. Group properties of authorization, access control, data security, and key management are defined precisely through the token. However, while these systems provide a great deal of flexibility in defining policy, the range of supported mechanisms and policies is largely fixed. Thus, addressing unforeseen or exceptional security demands requires additional application infrastructure.

The DCCM system developed by Branstad et al. allows the definition of flexible policies through Cryptographic Context Negotiation Templates (CCNT). Each template defines the types and semantics of the available mechanisms and parameters of a system. A principal aspect of the DCCM project is its use of policy as entirely defining the context in which a group operates. Policy may be negotiated or stated by an initiating member, and flexible mechanisms for policy representation and interpretation are defined. A DCCM policy focuses on the mechanisms implementing group security services; authorization and access control is defined independently of the derived group policy.

Mechanism composition has long been used as a building block for distributed systems. Composition-based frameworks specify the compile or run-time organization of sets of protocols and services used to implement a communication service. The resulting software addresses the requirements of each session. However, the definition and synchronization of specifications is largely relegated to system administrators and developers.

U.S. Pat. No. 5,968,176 suggests use of policies for configuring multiple firewalls. The policies are specific to firewalls, not group communication. A typical policy statement is one that allows Jon Doe to use the ftp communication port between Host 1 and Host 2 between Monday-Friday and enforce this at the destination. There is no notion of provisioning mechanisms (e.g., keying mechanisms, authentication mechanisms) to be used for enforcing security in multi-party communication. Also, there is no notion of reconciling local policies. Policy is centrally determined.

U.S. Pat. No. 6,170,057 applies to two-party communication between a mobile computer and the visited network. The intent is for a mobile node to be able to change the encryption function when it moves to a different network. The mobile computer is provided with a packet encryption and authentication unit having an ON/OFF switchable function for applying an encryption and authentication processing on input/output packets. This patent does not apply to multi-party communication.

U.S. Pat. Nos. 6,215,872 and 6,134,327 allow end-users to obtain lists of trusted public keys from other end-users and from associated authorities. A security policy specifies the manner in which these keys can be obtained. The invention is specific to the problem of acquiring public keys of other users in a distributed system according to a specified policy. There is no notion of the generalization of the system to handle provisioning or access control, policy analysis, policy reconciliation, or policy compliance checking.

U.S. Pat. No. 5,787,428 uses security and user tags for controlling access to information in a database.

U.S. Pat. No. 5,950,195 describes a system and method for regulating the flow of connections through an IP-based firewall. Firewall rules may trigger activation of authentication protocols so that a connection is allowed only if the authentication protocol completes successfully. This invention is specific to firewall configuration and there is no notion of establishing a policy instance from a group policy and local policies.

U.S. Pat. No. 6,072,942 describes a method for filtering electronic mail messages. The filtering is specified by a filter policy. The filter policy can specify how mail sent and received from external locations should be handled (e.g., logged, reviewed for content, discarded, etc.). The invention is specific to filtering electronic mail. There is no notion of achieving secure group communication by establishing a policy instance from a group policy and local policies.

U.S. Pat. No. 6,202,157 describes how policy data can contain provisioning information. The example provisioning data identified include password lengths, password aging, cryptographic algorithms, and key lengths. The policy data is centrally defined and digitally signed. It is then distributed to all the network nodes, who verify the digital signature, and then install the policy. However, there is no notion of access control policies and no general purpose enforcement architecture is described, and there is no notion of events.

U.S. Pat. No. 6,192,394 describes a system to allow users in a collaboration session to download collaboration software from one or more servers. The collaboration software can use a user list that is provided by a directory publishing software to determine the set of users with whom communication is allowed. The patent does not cover communication security via encryption. There is also no notion of group and local security policies.

U.S. Pat. No. 5,991,877 discloses a data processing system including an access control system that includes an object-oriented trusted framework that allows for one or more policy managers for enforcing access control on system resources. The goal of the invention is to design an object-oriented framework to ease development and alteration of access control systems by supporting security policies. The architecture decouples security policy from security enforcement. The abstract mentions the possibility of reconciliation of security policies having inconsistent requirements. However, the patent does not say how reconciliation might occur. It appears that the intent is that the object-oriented framework allows easier customization of policy enforcement system via code reuse for a potentially incompatible policy. Access control is from a single computer. There is no notion of provisioning in security policies, only for role-based and mandatory access control to resources. There is no support for group and local policies, or a method for reconciling them to determine a policy instance.

U.S. Pat. No. 6,158,007 allows publishers and subscribers in a communication system to receive a security policy from a broker. The security policy includes an access control list and the quality of protection of messages. The policy describes both provisioning and authorization. However, the form of the policy is very limited. There is no support for reconciling multiple policies, analyzing a security policy, or checking compliance of a policy with a local policy. The security policy corresponds to a policy instance. The security policy includes both access control and basic aspects of provisioning security. It is not a general security policy since no conditionals are supported and no support is provided for mechanism configurations.

U.S. Pat. No. 6,158,010 describes a method for security policy distribution from a central node to clients where the security policy specifies access control to securable components. With respect to distribution, the security policy corresponds to a policy instance. However, there is also no support for provisioning of mechanisms in the policies. It only supports access control. Access control rules can have conditions. However, there is no support for reconfiguration of a policy when an operation is attempted. The access control language is general (it allows DENY statements); thus it would be difficult to support automated policy analysis, reconciliation, or compliance checking with other policies. Policy analysis to determine if a policy satisfies a given set of assertions is not provided. The policy analysis is used to query policy rules rather than determine satisfaction of a set of assertions. There is no support for reconciling group and local policies to determine a policy instance or checking compliance of a local policy with a policy instance, etc.

U.S. Pat. No. 6,052,787 describes a protocol used for transmitting proposals and counter-proposals between group members. Policy is confined to provisioning only. There is no discussion of how security policy counter-proposals are defined. There is no concept of local policies, compliance or analysis. Policy is provided through negotiation, rather than created through reconciliation. The patent, however, is concerned with n-party communication and the idea that policies exist on each member, and that the policy enforced over the group is the product of those policies. However, the patent does not say anything how this happens, about compliance, etc. The patent does not say anything about how policy is determined. It only suggests how one may deliver policy toward a central member who will respond with a group defining policy.

U.S. Pat. No. 6,098,173 is concerned with the detection and rejection of undesirable down-loadable executables (e.g., Java applets). The invention marks packets from trusted sources such that receivers can determine that the applets themselves are trusted.

### SUMMARY OF THE INVENTION

An object of the present invention is to provide an improved method and system for determining and enforcing security policy in a communication session for a group of participants.

In carrying out the above object and other objects of the present invention, a method for determining and enforcing security policy in a communication session for a group of participants is provided. The method includes providing group and local policies wherein each local policy states a set of local requirements for the session for a participant and the group policy represents a set of conditional, security-relevant requirements to support the session. The method also includes generating a policy instance based on the group and local policies. The policy instance defines a configuration of security-related services used to implement the session and rules used for authorization and access control of participants to the session. The method includes analyzing the policy instance with respect to a set of correctness principles. The method further includes distributing the policy instance to the participants and enforcing the security policy based on the rules throughout the session.

The step of distributing may include the steps of authorizing a potential participant to participate in the session based on the rules and determining whether the potential participant has a right to view the security policy.

The step of analyzing may verify that the policy instance adheres to a set of principles definig legal construction and composition of the security policy.

The step of generating may include the step of reconciling the group and local policies to obtain the policy instance which is substantially compliant with each of the local policies. The policy instance identifies relevant requirements of the session and how the relevant requirements are mapped into the configuration.

The method may further include verifying that the policy instance complies with the set of local requirements stated in the local policies.

The method may further include identifying parts of a local policy that are not compliant with the policy instance and determining modifications required to make the local policy compliant with the policy instance.

The method may further include preventing a potential participant from participating in the session if the policy instance does not comply with the set of local requirements of the potential participant.

The step of enforcing may include the steps of creating and processing events. The step of creating events may include the step of translating application requests into the events.

The step of enforcing may include delivering the events to security services via a real or software-emulated broadcast bus.

The step of enforcing may further include the steps of creating and processing timers and messages.

The set of local requirements may specify provisioning and access control policies.

Further, in carrying out the above object and other objects of the present invention, a system for determining and enforcing security policy in a communication session for a group of participants based on group and local policies is provided. Each local policy states a set of local requirements for the session for a participant and the group policy represents a set of conditional, security-relevant requirements to support the session. The system includes means for generating a policy instance based on the group and local policies. The policy instance defines a configuration of security-related services used to implement the session and rules used for authorization and access control of participants to the session. The system includes means for analyzing the policy instance with respect to a set of correctness principles. The system further includes means for distributing the policy instance to the participants and means for enforcing the security policy based on the rules throughout the session.

The means for distributing may include means for authorizing a potential participant to participate in the session based on the rules and determining whether the potential participant has a right to view the security policy.

The means for analyzing may verify that the policy instance adheres to a set of principles defining legal construction and composition of the security policy.

The means for generating may include means for reconciling the group and local policies to obtain the policy instance which is substantially compliant with each of the local policies. The policy instance identifies relevant requirements of the session and how the relevant requirements are mapped into the configuration.

The system may further include means for verifying that the policy instance complies with the set of local requirements stated in the local policies.

The system may further include means for identifying parts of a local policy that are not compliant with the policy instance and determining modifications required to make the local policy compliant with the policy instance.

The system may further include means for preventing a potential participant from participating in the session if the policy instance does not comply with the set of local requirements of the potential participant.

The means for enforcing may include means for creating and processing events. The means for enforcing may include a real or software-emulated broadcast bus to deliver the events to security services. The means for creating events may include means for translating application requests into the events.

The means for enforcing may further include means for creating and processing timers and messages.

The method and system of the present invention provide flexible interfaces for the definition and implementation of security policies through the composition and configuration of security mechanisms. The set of services and protocols used to implement the group is developed from a systematic analysis of the properties appropriate for a given session in conjunction with operational conditions and participant requirements. The resulting session defining policy is distributed to all group participants and enforced uniformly at each host.

In the method and system of the present invention, a group policy is the specification of all security relevant properties of the session. Thus, a group policy states how security directs behavior, the entities allowed to participate, and the mechanisms used to achieve security objectives. This view of policy affords a greater degree of coordination than found in extant systems; statements of authorization and access control, key management, data security, and other aspects of the group are defined within a single unifying policy.

The method and system of the present invention improves upon the prior art by defining an approach in which policy is used to provision and regulate the services supporting communication. Furthermore, group participants can determine the compliance of the group definition with local requirements.

The method and system of the present invention seek to extend compositional systems by defining an architecture and language in which security requirements are consistently mapped into a system configuration from real-time generated specifications.

Several recent group communication systems, including DCCM, GSAKMP, and a prior art version of the present invention support the notion of security policies defining detailed security service provisioning. In all these systems, generally, the range of group security policy is static. In that sense, the policy instance generated from the present invention can be considered as the policy input to these group communication systems. The present invention extends these systems by stating the conditions under which certain policies should be enforced. In addition, the present invention expresses policies that involve aspects of both provisioning and access control (support for the latter is limited in the above systems).

The problem of reconciling multiple policies in an automated manner is only beginning to be addressed. In the two-party case, the emerging Security Policy System (SPS) defines a framework for the specification and reconciliation of local security policies for the IPSec protocol suite. To handle a similar situation in the present invention, two local policies for the two ends of the IPSEC connection can be specified. These policies will be resolved against a group policy that leaves the choice of mechanisms open.

In the multi-party case, DCCM system provides a negotiation protocol for provisioning. The first phase of the protocol involves the initiator sending a policy proposal to each potential member and receiving counter proposals. Subsequently, the initiator declares the final policy that potential members can accept or reject, but not modify. Policy proposals define an acceptable configuration (which, for particular aspects of a policy, can contain wildcard “don't care” configurations). An advantage of this protocol is that the local policy need not be revealed to the initiator. The present invention, if desired, can be easily adapted to use the DCCM's negotiation protocol. The present invention is more expressive because it can be used to state conditions under which various configurations can be used and when configurations need to be reconsidered in response to actions. The authorization and access control model is also more general in the present invention.

Language-based approaches for specifying authorization and access control have long been studied, but they generally lack support for provisioning. Because of the vast earlier work in this area and to simplify the language design, the present invention does not attempt to be as expressive for stating complex access control rules. Instead, the present invention is designed to leverage the expressive power of other access control systems via external authorization services.

The PolicyMaker and KeyNote systems provide a powerful and easy-to-use framework for the evaluation of credentials. Generally, support for provisioning and resolving multiple policies is not the focus of these systems. When desired, these systems can be invoked in conditionals of the present invention to leverage their expressive power and extend their use to group communication systems.

KeyNote has been used to define a distributed firewall application. The technique is to use conditional authorizations, where conditions involve checking port numbers, protocols, etc. However, it still remains problematic to construct a configuration, based on multiple local policies, or for determining the correctness of a configuration. The provisioning clauses and legal usage assertions of the present invention can help address these problems.

### BRIEF DESCRIPTION OF THE DRAWINGS

FIG. 1 is a schematic block diagram of a model of the system of the present invention wherein a session is a collection of participants collaborating toward some set of shared goals; a policy issuer states a group policy as a set of requirements appropriate for future sessions; the group and expected participant local policies are reconciled to arrive at a policy instance stating a concrete set of requirements and configurations; prior to joining the group, each participant checks compliance of the instance with its local policy;

FIG. 2 is a schematic block diagram illustrating mechanism signal interfaces; policy is enforced through creation and processing of events, timers, and messages; to simplify, events are posted to and received via an event bus; the expiration of timers registered to the timer queue is signaled to the mechanism through a process timer interface; messages are sent to the group via the send message interface, and received through the process message interface;

FIG. 3 is a schematic block diagram of an event bus; the event bus manages the delivery of events between the group interface and mechanisms of the invention; events are posted to the bus controller event queue; events are subsequently broadcast to all software connected to the bus in FIFO order; the event bus is preferably implemented in software and is completely independent of network broadcast service supported by the broadcast transport layer;

FIGS. 4a-4d are schematic block diagrams illustrating policy enforcement; an application sendMessage API call is translated into a send event (SE) delivered to all mechanisms in FIG. 4a; this triggers the evaluation of an authentication and access control policy via upcall in FIG. 4b; and ultimately to the broadcasting of the application data in FIG. 4c; the send triggers further event generation and processing in FIG. 4d; the policy engine does not listen to or create events;

FIG. 5 is a schematic block diagram illustrating four components of the present invention: the group interface layer, the mechanism layer, the policy engine, and the broadcast transport layer; the group interface layer arbitrates communication between the application and the lower layers through a simple message oriented API; the mechanism layer provides a set of software services used to implement secure groups; the policy engine directs the configuration and operation of mechanisms through the evaluation of group and local policies; the broadcast transport layer provides a single group communication abstraction supporting varying network environments;

FIGS. 6a and 6b are schematic block diagrams illustrating operation of an authentication mechanism; the authentication mechanism is initialized by the policy engine (a), after which authentication request event is received; the mechanism responds by locating the authentication service at the initiator and establishing a secure channel (b,c,d); after authenticating the group (e), the channel is used to exchange policy and session state (f); the authentication process is completed by posting a policy received and authentication complete event (g,h) to the event controller;

FIG. 7 is a schematic block diagram illustrating generalized message handling (GMH); GMH abstracts the complex tasks of data marshaling; senders associate data with each field defined in a runtime modifiable (AmessageDef) message template object; GMH marshals the data as directed by the template using the supplied information; receivers reverse the process by supplying additional context (such as decryption keys) based on previously unmarshaled fields; in the figure, shaded boxes represent marshaled or unmarshaled data (at the sender and receiver, respectively) and dots represent known field values;

FIG. 8 is a schematic block diagram illustrating a reliable transport layer; and

FIG. 9 is a schematic block diagram wherein the Socket_s Library acts as a “bump in the stack” by redirecting all multicast traffic toward interfaces of the present invention.

### DETAILED DESCRIPTION OF THE PREFERRED EMBODIMENTS

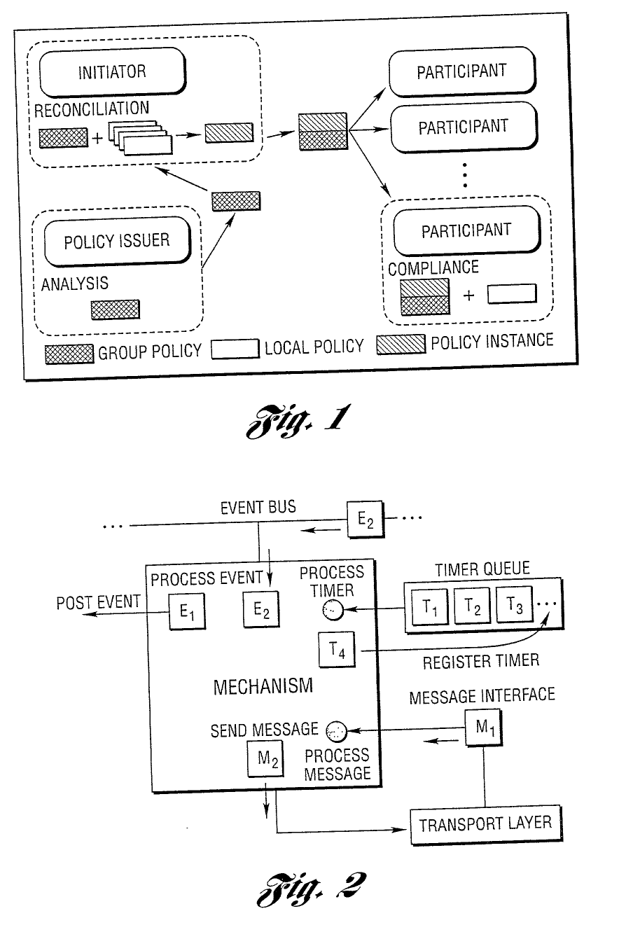

Referring now to FIG. 1, a group of the present invention is modeled as the collection of participants collaborating toward a set of shared goals. The existence of a policy issuer with the authority to state session requirements is assumed. The issuer states the conditional requirements of future sessions through the group policy. Adherence of a group policy to a set of correctness principles (describing legal security policies) is assessed through an analysis algorithm. A group policy is issued only if the analysis algorithm determines that the policy conforms to these principles.

Each participant states its set of local requirements on future session through a local policy. Each participant trusts the issuer to create a group policy consistent with session objectives. However, a participant can verify a policy instance meets the requirements stated in their local policy through the compliance algorithm. Failure of the group policy to comply to the local policy can result in the modification of the local policy or the abstention of the participant from the session.

An initiator is an entity that generates a policy instance from group and local policies. A service used to acquire local policies prior to reconciliation is not described herein but this service may be viewed as part of the session announcement protocol.

A policy instance is the result of the reconciliation of the group and local policies within the run-time environment. Through reconciliation, an instance identifies relevant session requirements, and defines how requirements are mapped into a configuration. The initiator is trusted to evaluate the group and local policies correctly.

An interactive policy negotiation protocol is not described herein. However, each participant defines the range of acceptable policies through local policies. Reconciliation attempts to find an instance that is compliant with each local policy as described herein below. Hence, the method and system of the present invention provide implicit negotiation through the evaluation of local policies.

A policy instance defines the session configuration (provisioning) and the rules used for authorization and access control. Provisioning of a group identifies the basic security requirements and the mapping of those requirements into a configuration of security-related services or mechanisms at member sites. Authorization and access control statements define how sessions regulate action within the group.

Participant software is modeled as collections of security mechanisms. Each mechanism provides a distinct communication service that is configured to address session requirements. Associated with a mechanism is a set of configuration parameters used to direct its operation. An instance defines precisely the set of mechanisms and configuration used to implement the session. For example, a data security mechanism implements transforms that enforce content security policies (e.g., message confidentiality, integrity, source authentication). The data security mechanism configuration identifies which transforms are used to secure application messages as described herein below.

Similar to other secure group communication frameworks, the distribution of the policy instance is a two-phase process. Potential group participants mutually authenticate themselves with the initiator. The instance is distributed following authentication only if the initiator determines that the participant has the right to view the policy (as determined by the instance access control policy). The member joins the group if the received instance is compliant with its local policy.

Because the instance defines the policy used throughout the lifetime of the group, no further policy synchronization is necessary. However, as described herein below, specialized reconfig events can trigger the policy re-evaluation. In this case, the group is disbanded and re-initialized under a newly established instance.

The method and system of the invention provide end-to-end group security service. In this, each participant acts as a policy enforcement point (PEP). Many environments may benefit from the introduction of other non-participant PEPs (e.g., policy gateways, IPSec tunnels, etc.)

The method and system of the present invention assumes that a policy determination architecture is available. For example, a current embodiment of the invention includes Ismene. However, the invention is not dependent on Ismene. Other group policy specifications (e.g., GSAKMP policy token, DCCM Cryptographic Context) can be used to direct the services of the present invention. However, the use of these policy specifications requires the creation of software compliant with the policy interfaces of the present invention.

Policy Language

Each group and local policy is explicitly stated through a policy specification. The prototype Ismene Policy Description Language (IPDL) defines the format and semantic of these specifications. Ismene is a subsystem defining a grammar and algorithms for the process of policy determination and analysis.

An IPDL policy is defined through a totally ordered set of clauses, where the ordering is implicitly defined by their occurrence in the specification. Each clause is defined by a tuple of tags, conditions, and consequences. Conditions test some measurable aspect of the operating environment, group membership, or presence of credentials. Consequences define what policies are to be applied to the group. Tags provide structure to the specification by directly defining the relations between sub-policies.

The following presents a subset of clauses from a typical IPDL group policy.

% Key Management Provisioning

key_management: GroupIncludes(Manager), GroupSmaller(100) :: Config (LKHKeyMnger(rekeyOnJoin=true, rekeyOnLeave=true));

key_management: :: Config (KEKKeyMnger (rekeytimer=300));

% Data Handling Provisioning

data_handling: :: Pick (Config(adhdlr(conf=des)), Config (adhdlr(conf=aes)));

% Join Authorization and Access Control

join: Credential (Role=Manager, IssuedBy=$Trusted_CA) :: accept;

join: Credential (Role=SoftwareDesigner, IssuedBy=$Trusted_CA) :: accept;

The following example describes how a provisioning policy is derived from these clauses. The key_management clauses identify several key management policies appropriate for different operating environments. Initially, the initiator evaluates the conditionals associated with the first key_management clause. The GroupIncludes conditional tests whether a manager is expected to participate in the group. The GroupSmaller conditional tests whether the expected group will contain less than 100 members. Conditionals form a logical conjunction, where all conditionals must evaluate to true for the clause to be satisfied. If a clause is satisfied, then the consequences are applied to the policy. In this example, if a manager is present and the group will contain less than 100 members, the LKHKeyMnger mechanism will be used with the identified configuration (i.e., rekeyOn-Join=true and rekeyOnLeave=true).

In the event the first clause is not satisfied, the second clause is consulted. This second clause represents a default policy; because it does not contain any conditions, it is always satisfied. Thus, where the first clause is not satisfied, the group falls back to a default Key-Encrypting-Key key management policy. However, if the first clause is satisfied, the second clause is ignored.

The data_handling clause illustrates the use of the pick consequence. Pick consequences afford the initiator flexibility in developing the session. Semantically, the pick statement indicates that exactly one configuration must be selected. In the example, pick is used to state flexible policy; either DES or AES can be used to implement confidentiality, but not both or neither. The reconciliation process assesses the group and local policies to determine the most desirable configuration in the pick statement as described herein below.

Authorization and access control are performed after the group has been provisioned. Typically, the evaluation of authorization requests test the presence of credentials proving a member's right to perform some action (e.g., join the group). The simple join rules defined above state that any member who presents credentials issued by a trusted CA delegating the right to act as a Manager or SoftwareDesigner will be permitted into the group. Through the use of conditionals, a large number of complex authorization and access control models may be defined.

Reconciliation

The group policy is reconciled with the local policies of the expected participants to arrive at a concrete configuration. Thus, reconciliation determines which requirements are relevant to a session, and ultimately how the session is implemented. Ismene group policies are authoritative; all configurations and pick statements used to define the instance must be explicitly stated in the group policy. Local policies are consulted only where flexibility is expressly granted by the issuer through pick statements.

Reconciliation is the process by which configurations from pick statements in the group policy are selected. The selection process is guided by the configuration and pick statements in the local policies. Reconciliation appears on first viewing to be intractable. However, by restricting the structure and contents of IPDL policies, one can develop an efficient reconciliation strategy. The prior art formulates the reconciliation problem and considers the complexity of the most general case. Several strategies are proposed and analyzed. This analysis lead to the efficient Prioritized Policy Reconciliation (PPR) algorithm used by the implementation.

For brevity, many details of the IPDL construction, algorithms, and use have been omitted. Further details are found in P. McDaniel and A. Prakash, “Ismene: Provisioning and Policy Reconciliation in Secure Group Communication,” Technical Report CSE-TR-438-00, Electrical Engineering and Computer Science, University of Michigan, Dec. 6, 2000.

Implementing Policy

Inter-component communication in the invention is event based. The observation of a security relevant event by any component is translated into an event object. Where policy decision is required, this event is posted to the policy engine event queue. If, based on the policy instance, the engine determines that further processing is warranted, the event is posted to the appropriate layer or application.

For example, consider an application wishing to broadcast a message to the group. The application initially makes the SendMessage( ) API call (herein below) with the data to be sent. The mechanism layer translates this call into a SEND event, which is posted to the policy engine event queue. The policy engine checks the policy instance, local credentials, and operational conditions to determine if the application has the right to send content to the group.

Consulting authorization and access control policy on each relevant action may seriously affect performance. The invention mitigates these costs by evaluating not only action acceptance or denial, but also the conditions under which the result should continue to be considered valid (i.e., invariant result, timed validity result, transient result). Therefore, authorization and access control policies need only be consulted when a valid previous result is unavailable.

If permitted, the SEND event is posted to the mechanisms layer. The mechanisms layer allows each mechanism to process the event. In processing the event, the Data Security mechanism will perform a transform designed to provide the provisioned data security guarantees (e.g., confidentiality). The result is broadcast to the group via the transport layer.

Upon reception of the message, other participants translate the received message into a RECV event and post it to their local policy engine. The right of the sender to transmit data will be assessed with respect to the access control policy defined in the instance. If admitted, the reverse transform is performed by the Data Security mechanism on the received data. Once the original content is recovered, it is delivered to the application.

The processing of a single event may trigger the enforcement of many policies. For example, a NEW PARTICIPANT event (representing a newly admitted member) may require the initiation of session rekeying, the creation of new process monitoring timers (for failure detection and recovery), etc. The enforcement of each of these policies may lead to the generation of other events (e.g., INIT REKEY), authorization and access control decisions, and/or session traffic.

A central goal of Ismene (and the present invention) is the easy integration of additional services and conditionals. To this end, the invention provides simple APIs for the creation of conditionals, mechanisms, and configurations. Developers create new mechanisms by constructing objects conforming to the Amechanism API. Developer stated unique identifiers (defining the mechanism and its configurations) can be added to IDPL policies, and are subsequently used as any other mechanism.

Application or mechanism specific conditions can be implemented through the ApolicyImplementor interface. ApolicyImplementor objects define one or more conditions to be used by Ismene. The unique identifiers associated with these conditionals can be immediately added to IDPL policies. Ismene performs an upcall to the implementor object upon encountering a defined conditional. The object is required to evaluate the conditional and return its result.

Policy Creation

Central to the security of any application is the definition of application policies. Each application, environment, and host can have unique requirements and abilities which must be reflected in the local and group policies. The apcc tool is used to assess the policies with respect to these requirements.

apcc is a policy compiler; group and local policies are assessed to ensure a) the policy has the correct syntax (i.e., conforms to the policy language grammar), and b) is consistent with a set of user supplied assertions (which define correct usage principles). Any policy specification not conforming to the policy grammar is rejected by apcc.

Policy assertions define the correct usage of the underlying security mechanisms; dependencies and incompatibilities between different mechanisms are identified. For example, the following assertion identifies a dependency between security mechanisms;

assert: config (1khkeymgt( )):: config (membership(leave=explicit)); This assertion states that all systems implementing a Logical Key Hierarchy must also implement explicit (member) leaves. The analysis algorithm implemented by apcc determines if any possible instance resulting from reconciliation violates this assertion (i.e., the instance defines an LKH mechanism, but not enforce an explicit leave policy). The user is warned of any such possible violation. In addition, policies which are irreconcilable (i.e., policies which, due to their construction, will always cause the reconciliation algorithm to fail) are identified.

Once policies have been created, they can be stored in any available repository. For example, an LDAP service can be used to store and retrieve group and local policies. This approach is useful where the local domain wishes to enforce a set of security policies for all applications, or where users do not have the desire or sophistication to state policy. Each policy is evaluated by the invention for freshness, integrity, and authenticity prior to its use.

Applications Programming Interface

The API of the invention abstracts group operations into a small set of message oriented interfaces. Conceptually, an application need only provide group addressing information and security policies appropriate for the application (see below). Once the group interface is created, the application can transmit and receive messages as needed.

The current implementation of the invention consists of approximately 30,000 lines of C++ source and has been used as the basis for several non-trivial group applications (see below). All source code and documentation for the Policy Description language, the framework, and applications are freely available. The six libraries comprising the invention are described as follows:

| Directory | Name | Description |
|---|---|---|
| atk | Toolkit | basic set of objects implementing basic data |
| | | and structures (e.g., queues, timers, strings, |
| | | . . . ) and cryptographic functions (e.g., keys, |
| | | hash functions, digital certificates, . . . ) used |
| | | by the other libraries. |
| atrans | Transport | interfaces for an abstract broadcast channel in |
| | Layer | varying network environments. This |
| | | embodies the entirety of the transport |
| | | library described below. |
| amech | Mechanism | abstract interfaces and classes upon which |
| | Layer | specific secure group mechanisms are built, |
| | | coordinates the operation of mechanisms |
| | | as directed by the policy instance. |
| mechs | Mechanisms | collection of mechanisms defining the services |
| | | under which a group can be constructed. |
| | | Policies are enforced using these basic services. |
| apdl | Policy | provides interfaces for the definition and |
| | Description | evaluation of policies. The lexical analyzer |
| | Language | and all policy algorithms are implemented in |
| | | this library. |
| agrp | Group - | Applications Programming Interface for secure |
| | Main API | groups. Applications communicate with the |
| | | invention through this API directly. |

The API separates group operation from the broadcast medium. This separation is reflected in the AGroup and ATransport APIs. The following subsections give an overview of the design, implementation, and interfaces of these libraries.

The following is a simple example application using the APIs.

| | |
|---|---|
| 1 | #include <stdlib.h> |
| 2 | #include <AGroup.h> |
| 3 | int main (int argc, char **argv) { // usage: simple [ host_name_of_server ] |
| 4 | if (getenv (“NAME”) == NULL) setenv (“NAME”, “unknown”, 1); set up id |
| 5 | |
| 6 | AGroup *group; // group object, policy files |
| 7 | String locPol = “local.apd.”, grpPol = “example.apd”, polList = “”; |
| 8 | |
| 9 | // Setup the transport layer address - multicast address and port |
| 10 | IPAddress *groupIp = IPAddress::IPAddressFactory(“224.1.1.27”, 9000); |
| 11 | // specify server and port (argv[1] is the host name of the server) |
| 12 | IPAddress *serverIp = |
| 13 | IPAddress::IPAddressFactory(argc==1?“224.1.1.27”:argv[1], 9001); |
| 14 | // Construct transport layer |
| 15 | ATransport *transport = |
| 16 | new ATransport(groupIp, serverIp->Port( ), ATransport::AT_SYMMETRIC) ; |
| 17 | |
| 18 | if (argc == 1) // server constructor for group - 5 parameters |
| 19 | group = new AGroup(transport, grpPol, locPol, polList, NULL); |
| 20 | else // client constructor for group - only 3 parameters |
| 21 | group = new AGroup(transport, locPol, NULL); |
| 22 | (void)group->Connect( ); |
| 23 | |
| 24 | // Set up a buffer and send it |
| 25 | String msg; |
| 26 | msg.sprintf (“Hello World from %s\n”, getenv(“NAME”)); |
| 27 | Buffer *buf = new Buffer( ); |
| 28 | (*buf) << msg; |
| 29 | group->sendMessage(buf); |
| 30 | |
| 31 | AtkTimer timer(60 * 1000); timer.reset( ); // wait for up to 60 seconds |
| 32 | while (group->readMessage(&buf, &timer)) { // read messages from group |
| 33 | (*buf) >> msg; |
| 34 | cout << “ Received: ” << (char*)msg; // extract message from buffer |
| 35 | delete buf; |
| 36 | } |
| 37 | group->Quit( ); // Leave, shutdown interface to the group |
| 38 | exit (0); |
| 39 | } |

The application creates a group object for a server if invoked with no parameters, or a client if invoked with the name of the server host. Each process sends one message and receives all application data arriving within 60 seconds. All line numbers cited in the following subsections refer to this example.

Group API

The AGroup object serves as a conduit for all communication between an application and the group. After this object is created (see below), all transmissions and receptions, state changes, and status probing are performed through AGroup member methods. The three phases of a group object include: initialization, operation, and shutdown.

The initialization of an AGroup object requires the member specify the appropriate policies and supply a transport object (lines 21 and 23 above).

The server constructor (line 21) supplies group and local policies which are reconciled to arrive at the session definig policy instance. Although not used in the example, the polList parameter identifies the list of local policies to be considered by the reconciliation algorithm. The client constructor (line 23) supplies its local policy and defers to the server for the instance. The Connect call (line 24) initializes the proper interfaces, joins the group, and retrieves or derives (through the reconciliation algorithm) the policy instance. Failures (either at the transport or group layers) generate an exception.

Subsequent sending, receiving, and processing of the messages during operation is achieved through an API similar to Berkeley Sockets (e.g., sendMessage—line 31, readMessage—line 34). sendMessage sends and eventually deletes buffers. readMessage creates a buffer object for each incoming message. The Buffer object simplifies the tasks of memory management and message marshaling. Buffer objects handle translations between machine bit formats, automatically resize as needed, and maintain an internal heap of message structures. These objects allow the invention to reduce the cost and simplify message memory management, translate between hardware and operating system platforms, and optimize message processing (e.g., reduce buffer copying).

The interface to the group is shutdown through the Quit API call. This call exits from the group (explicitly sending a leave message as dictated by policy), destroys sensitive information (e.g., keys, messages), and cleans up all internal data.

An example policy appropriate for the above application is presented as follows:

% File : example.apd
% Description : Example Group Policy
% Attributes Section
issr:= < iQBVAw . . . >;
% Provisioning Section
provision: :: authentication, membership,

keymgmt, datmgmt;

authentication: :: config(OpenSSL( ));
membership: :: config(amember(retry=3));
keymgmt: :: config(1khkey(sens=memsens));
datmgmt: :: config(adhdlr(guar=conf, conf=desx)),

config(adhdlr(guar=intg, intg=md5));

% Authorization/Access Control Policies
init: Credential(&cert, iss=$issr,

subj.CN=$joiner) :: accept;

join: Credential (&cert, iss=$issr, fs=$fsys,

subj.CN=$joiner) :: accept;

rekey: Credential(&key, key=$1khKey) :: accept;
send: Credential(&key, key+$sessKey) :: accept;
eject: Credential(&key, key=$sessKey) :: accept;
leave: :: accept;
% Policy Verification
signature := < sdD5aR . . . >;

This policy states a basic set of mechanisms are to be configured for the group; an OpenSSL mechanism for authentication, the imember membership management mechanism, a Logical Key Hierarchy key distribution mechanism, and the adhdlr data handler mechanism. The key management mechanism is configured to rekey after each membership change (e.g., member join or leave). The data handler mechanism is configured to provide confidentiality by encrypting all application traffic using DESX, and to provide integrity through keyed HMACs generated using the MD5 hash algorithm. The authorization and access control model for the group states that an appropriate certificate must be presented to gain access to the group, and that subsequent action is predicated on proof of knowledge of the appropriate session or key management keys.

An example local policy is presented as follows:

% File: local.apd

% Description: Example Local Policy

issr:=<iQBVAw . . . >;

% Requirements

provision: :: authentication, data_security;

authentication: :: config(OpenSSL( ));

data_security: :: config(adhdlr(guar=conf));

% No local policy regarding access control

join: :: accept; rekey: :: accept;

send: :: accept; leave: :: accept;

This local policy states that the local entity will only participate in groups that enforce a policy requiring OpenSSL authentication and which provide confidentiality of application traffic. The local policy states no requirements for group authorization (i.e., the local member accepts any authorization and access control model defined by the group policy).

Policy Enforcement

Enforcement is the process whereby the semantics of a policy are realized in software. Policy can be defined by separate, but related, aspects of policy representation, system provisioning and session authentication and access control. The following considers the goals of the present invention with respect to these facets of policy.

A policy representation determines the form and semantics of policy. Each environment may have different systems for determining and evaluating policy. Hence, as no single policy representation is likely to be applicable to all environments, enforcement should not be dependent on any policy determination architecture.

Provisioning defines the services and configurations used to support communication. However, the state provisioning found in monolithic security architectures is not appropriate for all environments. The requirements of an application may differ for each session. Hence, communication provisioning should be made in accordance with the run-time requirements dictated by policy. The effort required to integrate security services addressing new security requirements should be low.

Authentication and access control determines whom and in what capacity processes may participate in a session. A singular model or service for authentication access control is unlikely to meet the requirements of all environments. Hence, the invention supports a variety of authentication and access control services. While the enforcement of authentication and access control is preferably performed by the invention, the interpretation of policies (decision making) is deferred to the policy determination architecture.

Mechanisms

A mechanism of the present invention defines some basic service required by the group. Each mechanism is identified by its type and implementation. A type defines the kind of service implemented. The invention currently supports six mechanism types: authentication, membership management, key management, data handling, failure detection and recovery, and debugging. A mechanism implementation defines the specific service provided. For example, there are currently three key management implementations in Ismene: Key-Encrypting-Key, Implicit Group Key Management, and Logical Key Hierarchy. These categories are not exhaustive; new types (e.g., congestion control) or implementations (e.g., One-Way Function Tree Key Management) can be integrated with the invention easily. Associated with each mechanism is a set of configuration parameters (or just configurations). Configurations are used to further specify the behavior of the mechanism. For example, a data handling mechanism providing confidentiality may be configured to use triple-DES. Details of the current mechanisms are detailed herein below.

The set of mechanisms and configurations used to implement the session (provisioning) is explicitly defined by policy. The policy determination architecture is consulted at session initialization (or following policy evolution) for a provisioning policy. This policy is enforced by the creation and configuration of the appropriate mechanisms.

Unlike traditional protocol objects in component protocol systems, mechanisms are not vertically layered (e.g., layered services of TCP/IP stacks). This does not imply that an implementation be defined by monolithic or course-grained component protocol stacks. Each mechanism implements an independent state machine, which itself may be layered. For example, the Cactus-based membership service defined in the prior art can be used as a membership mechanism within the invention. In this case, the mechanism configuration determines the protocol graph constructed at run-time.

Signals

Internally, group operation is modeled in the invention as signals. Each signal indicates that some relevant state change has occurred. Policy is enforced through the observation, generation, and processing of signals. The invention defines event, timer expiration, and message signals.

Events signal an internal state change. An event is defined by its type and data. For example, send events are created in response to an application calling the sendMessage API. This event signals that the application desires to broadcast data to the group. A send event has the type EVT_SEND_MSG and its data is the buffer containing the bytes to be broadcast. A table of the basic events defined by the invention is presented in Table 1. Mechanisms are free to define new events as needed. This is useful where sets of cooperating mechanisms need to communicate implementation specific state changes.

TABLE 1
Basic Events - events signal a change of state in the group.
Mechanisms are free to define new events as needed.

| Event | Meaning | Data |
|---|---|---|
| EVT_AUTH_REQ | Authentication request | none |
| EVT_AUTH_COM | Authentication complete | join nonce |
| EVT_AUTH_FAL | Authentication failed | none |
| EVT_JOIN_REQ | Join request | join nonce |
| EVT_JOIN_COM | Join complete | None |
| EVT_JOIN_MEM | New user in group | member identifier |
| EVT_REJN_MEM | Member attempting to rejoin | member identifier |
| EVT_LEAV_REQ | Request to leave | none |
| EVT_EJCT_REQ | Request member ejection | member identifier |
| EVT_MEM_EJCT | A member has been ejected | member identifier |
| EVT_EJCT_COM | Member ejection | Boolean (TRUE = |
| | | successful) |
| EVT_MEM_LEAV | A Member has left the group | member identifier |
| EVT_LEFT_GRP | Local left group | none |
| EVT_NEW_GRUP | New group ID accepted | none |
| EVT_SEND_MSG | Send message | application data |
| EVT_SENT_MSG | A message has been broadcast | application data |
| EVT_DAT_RECV | Data message received | received |
| | | application data |
| EVT_KDST_DRP | Lost key distribution message | none |
| EVT_GROP_LST | Group communication lost | none |
| EVT_PRC_FAIL | Process failure | member identifier |
| EVT_CRECOVER | Client recover request | member identifier |
| EVT_POL_RCVD | Policy received | policy |
| EVT_NGRP_POL | New Group Policy | none |
| EVT_POL_EVGRP | Policy Evolution | policy |
| EVT_SHUTDOWN | Group Shutdown | shutdown the |
| | | interface to |
| | | the group |
| EVT_SHUT_COM | Group Shutdown Complete | shutdown |
| | | complete |
| EVT_INFO_MSG | Informational Event | information string |
| EVT_ERRORED | Signal Unrecoverable error | error description |
| | | string |

A timer expiration indicates that a previously defined interval has expired. Timers may be global or mechanism-specific; all mechanisms are notified at the expiration of a global timer, and the creating mechanism is notified of the expiration of a mechanism specific timer. Similar to events, a timer is defined by its type and data. For example, a join request retry mechanism timer may signal that a request has timed out. The timer data identifies context-specific information (a nonce) required to generate a join request. Timers are registered with a global timer queue (ordered by expiration). Timers may be unregistered (removed from the queue) or reset prior to expiration.

Messages are created upon reception of data from the underlying broadcast transport service (i.e., broadcast transport layer, as described herein below). Messages are specific to (must be marshaled/processed by) a mechanism. Every message m is defined by (and is transmitted with a header including) the tuple {mₜ, mᵢ, m_{g}}, where mₜ identifies a (one byte) mechanism type, mᵢ identifies a (one byte) mechanism implementation, and a (two byte) mₜ defining the message type. For example, the header {KEY_MECH, KEK_KEY_MECH, AKK_REKEY} header identifies a key management, KEK implementation, rekey message. Type, implementation, and message identifiers are used to partition the message identifier space. Header information is later used to route the message to the appropriate implementation for unmarshaling and processing (see below).

The interfaces used to create and deliver signals are presented in FIG. 2. Each signal types uses a process function to deliver the signal to the mechanism. Events are created and queued via the post event interface. Timers are created and placed in the timer queue via the register timer interface. Messages are sent to the group using the send message interface.

Group Interface

The group interface arbitrates communication between the application and mechanisms of the invention through a simple message oriented API. Actions such as join, send, receive, and leave are provided through simple C++ object methods. These actions are translated into events. Group state (e.g., received messages) are polled by the application through API calls.

The group interface implements event and timer signal processing functions. The group interface implementation does not directly send or receive messages. All communication with other processes is performed indirectly through mechanisms. However, the group interface acts as a de-multiplexer for received data. Messages receives from the group are forwarded to the appropriate mechanisms based on header information. Mechanisms subsequently unmarshal and process received messages.

The Event Bus

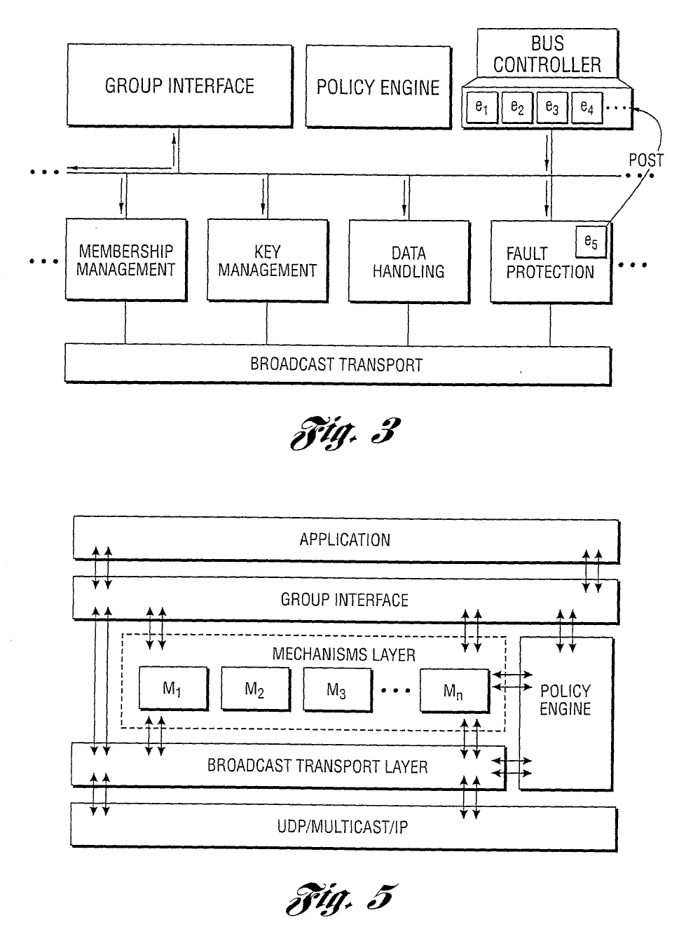

The event bus directs the delivery of events to mechanisms. Depicted in FIG. 3, the event bus defines the interface between the group interface and mechanisms. To simplify, all communication between these layers and between mechanisms is through the event bus. During initialization, as described herein below, the set of mechanisms defined by an instantiation are created and logically connected to the event bus. Mechanisms are removed from the bus when the group is destroyed or reprovisioned during policy evolution.

The bus controller is a software service that implements ordered delivery of events. The group interface and mechanisms post events to the bus controller. Posted events are subsequently delivered in FIFO order. Critical events (e.g., group errored) are placed at the head of the queue through a priority post.

Logically, the event bus is a broadcast service. All posted events are delivered to every mechanism and the group interface. Each mechanism processes events received on the bus in accordance with its purpose and configuration. After that, the mechanism signals the bus controller that the event has been processed. Unprocessed events are logged.

Event delivery is modeled as being simultaneous. The event bus guarantees that a) events are delivered in FIFO order, and b) an event will be delivered to all mechanisms and the group interface before any other event (including a priority event) is processed. These guarantees are preserved by mechanism acknowledgment of event processing completion. The event bus provides no guarantees on the ordering of mechanisms to which the event is delivered. This places additional requirements on event processing.

For example, consider a data handling service that transmits a message in response to a send event, and a group congestion control service that wishes to place an upper bound on transmissions per quanta. A naive implementation of a data handler would simply transmit data upon reception of a send event, and the congestion control mechanism would queue messages when the local member's fair share (of bandwidth) is exceeded. The naive implementation would thus (incorrectly) both transmit and queue the data. Several solutions to this problem exist. First, congestion control and data handling may be integrated into the same mechanism (which in many cases may not be possible or convenient). Second, one could require that all policies configuring congestion control must also configure the data handler to be cognizant of congestion control (e.g., through policy assertions). In this case, the data handler would ignore sent events, and only transmit in response to a congest_send event posted by the congestion control mechanism.

In general, dependencies between events are few. Hence, the response of a mechanism to a particular event is largely independent of other mechanisms. However, careful analysis of an effect of an event on all possible mechanisms is necessary. The composition mechanisms should be restricted (e.g., through assertions) to only allow compatible mechanisms and configurations.

Attribute Sets

State is shared by the components of the invention through the group attribute set. Similar to the KeyNote action environment of the prior art, the attribute set maintains a table of typed attributes. Attributes are defined through a {name, type, value} tuple. Mechanisms and the group interface are free to add, modify, or remove attributes from the table. Attributes are defined over basic data types (e.g., strings, integers, Boolean), identities (e.g., unique identifier), and credentials (e.g., keys, certificates). The group attribute set defines the current context of the group. For example, groups using a symmetric session key maintain the current session key through the SessionKey attribute. Mechanisms access the key by acquiring it from the group attribute set.

Authentication and access control decisions are deferred to the Policy Engine, as described herein below. However, mechanisms must supply information describing the context under which a particular action is attempted. The mechanism testing an action constructs an action set (which is frequently a subset of the group attribute set) from relevant information. The context primarily consists of the credentials used to prove identity and rights. All cryptographic material (e.g., keys, certificates) are modeled as credentials. Mechanisms provide the set of credentials and attributes associated with the action being performed through the action set. For example, a certificate provided by a joining member may be used as a credential to gain access to the group. The mechanism must decide, based on information provided, on the appropriate set of attributes to provide to the policy engine. For example, acceptance of an incoming packet encrypted under a current session key implies knowledge of the session key. Hence, the session key can be used as credential when assessing acceptance. The action being attempted is defined through the action attribute. Table 2 presents basic actions used in the current implementation.

TABLE 2
Basic Actions - actions under which authentication and access
control policy is defined. New actions
may be introduced by mechanisms and applications as needed.

| Action | Meaning |
|---|---|
| group_auth | member authentication of group |
| member_auth | group authentication of member |
| acquire | a potential participant policy acquisition |
| join | a member access to the group |
| view_dist | accept a view distribution |
| eject | request the ejection of another member |
| leave | accept a leave request |
| leave_resp | accept a leave response |
| key_dist | accept a key distribution |
| rekey | accept a group rekey |
| send | send data to the group |
| content_auth | source authenticate data |
| group_mon | accept a group monitor information |
| member_mon | accept a member monitor information |
| accept_policy | accept a policy instantiation |
| reconfig | initiate policy evolution |
| shutdown | accept a shutdown message |

Policy Enforcement Illustrated

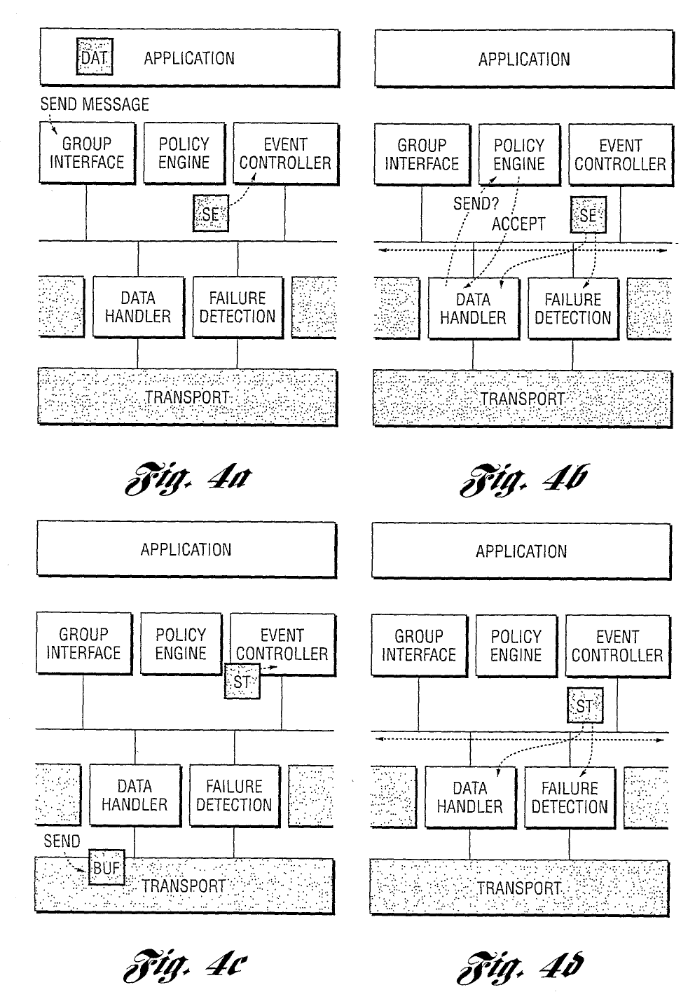

This section briefly illustrates how the group interface, policy engine, event controller, and mechanisms work in concert to enforce policy. The following example demonstrates the enforcement of data security, failure detection, and authentication and access control policies associated with the sending of an application message. The policy under which this example is defined requires application content confidentiality. Furthermore, the policy requires failure detection to be supported through a timed heartbeat detection mechanism, as described herein below. FIGS. 4a-4d and the following text illustrate how this policy is enforced (where the letters a, b, c and d correspond to FIGS. 4a, 4b, 4c and 4d, respectively).

a) The application attempts to broadcast data to the group via the sendMessage API call. The call is translated into an EVT_SEND_MSG event (SE) by the group interface, which is posted to the event controller. The application data (Dat) is encapsulated by the send event.

b) The event controller delivers the send event to all mechanisms. The data handler tests the send action in response to the delivery of this event by an upcall to the policy engine. Credentials supplied by the local user are passed to the policy engine. For this example, the policy engine accepts the send action.

c) The data handler mechanism encrypts the application data using a session key obtained from the attribute set. A confidentiality only message is constructed by placing the appropriate headers and encrypted data into a buffer (Buf). The buffer is then broadcast to the group via the transport layer. An EVT_SENT_MSG (ST) containing the sent buffer is posted to the event queue following the transmission.

d) The sent event is posted to all mechanisms. The failure detection mechanism, using the send as an implicit heartbeat message, resets an internal heartbeat transmission timer.

Other policies may dictate very different behavior. For example, the kinds of data transforms and the reaction of mechanisms to sent data may be very different. This is the promise of policy driven behavior; an application can specify precisely the desired behavior through the definition of group provisioning and authentication and access control.

Architecture

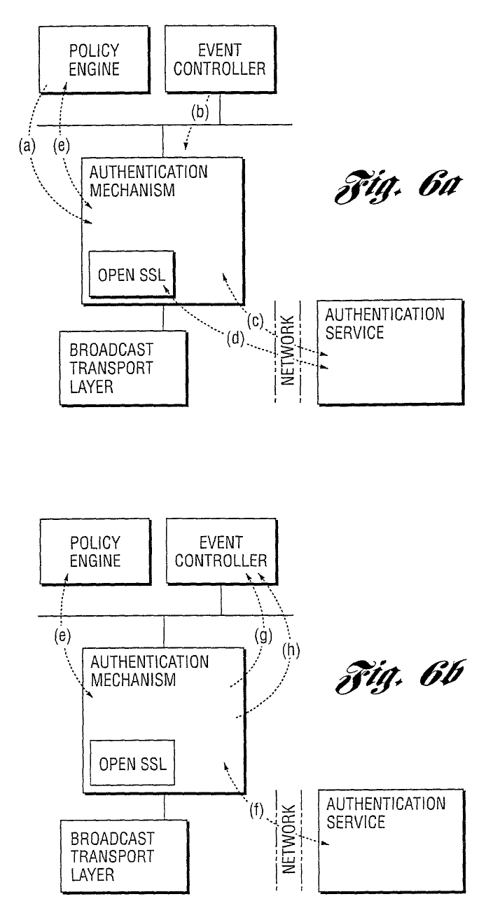

Described in FIG. 5, the architecture of the present invention consists of four components: the group interface layer, the mechanism layer, the policy engine, and the broadcast transport layer. The group interface layer arbitrates communication between the application and lower layers of the invention through a simple message oriented API (a brief overview of this API is given herein below). Group relevant actions such as join, send, receive, and leave are provided through simple C++ object methods. These actions are translated into events delivered to the other layers of the invention. Group events (e.g., message received) are polled by the application through the API.

The mechanism layer provides a set of mechanisms used to implement security policies. The mechanisms and configuration to be used in a session are defined by the policy instance. While the invention implementation currently provides a suite of mechanisms appropriate for many environments, new mechanisms can be developed and integrated with the invention easily. Note that mechanisms need not only provide security services; other relevant functions (e.g., auditing, failure detection and recovery, replication) can be implemented through the invention mechanisms. For example, the current implementation implements a novel secure crash failure detection mechanism.

The policy engine directs the configuration and operation of mechanisms through the evaluation of policies (i.e., reconciliation and compliance checking). Initially, as directed by the policy instance, the policy engine provisions the mechanism layer by initializing and configuring the appropriate software mechanisms. Subsequently, the policy engine governs protected action through the evaluation of authorization and access control policy.

The broadcast transport layer defines a single abstraction for unreliable group communication. Due to a number of economic and technological issues, multicast is not yet globally available. Thus, where needed, the invention emulates a multicast channel using the available network resources in the transport layer.

Alternative Architectures

While many aspects of the architecture of the present invention are prevent in previous works, the unique requirements of policy enforcement made the direct use of existing component frameworks inappropriate. Centrally, the need to compose re-configurable, tightly coupled, and fine-grained protocol components dictated the development of infrastructure not present in extant systems.

Group Interface

The group interface acts as a conduit for communication between the application and the mechanisms, and performs the high level direction of the policy management. These duties include the translation of application requests into events, the coordination of mechanism initialization and operation, and the queuing of incoming and outgoing data.

As detailed herein below, the group interface consults the local policy for an initial configuration (prior to receiving the policy instantiation). This policy (minimally) defines a service used to initiate communication with the group and acquire the instantiation. Once the group interface and mechanisms are initialized, the application is required to call the blocking Connect API. This call is translated into an EVT_AUTH_REQ event posted to the event controller. The various mechanisms will perform authentication in response to this event (see authentication mechanism herein below). The completion of the authentication process is signaled through the EVT_AUTH_FAL (authentication failed) or EVT_AUTH_COM (authentication successful) event. If authentication fails, an error is reported to the application. If authentication is successful, an EVT_POL_RCVD event identifying the instantiation is posted by the authentication mechanism. The group interface passes the opaque policy structure associated with the event to the policy engine. The policy engine deactivates the initial configuration and configures the mechanisms layer as dictated by the instantiation. Once the policy engine completes this task, an EVT_NGRP_POL initialization event is posted, and the Connect call returns.

The group interface provides a simple message oriented API. However, an application desiring to view the current membership, obtain the current group state, or access policy is free to use advanced interfaces. Each relevant API call is translated into an event by the group interface. For example, an EVT_SEND_MSG event is created in response to an application sendMessage API call. The event is posted to the event controller and ultimately delivered to the mechanisms via the event bus.

Similarly, relevant events delivered to the group interface over the event bus are signaled to the application. The means by which this signaling is achieved is event-specific. Upon reception of an EVT_DAT_RECV event, the group interface places the message buffer associated with the event on the receive queue. The application can determine the state of the receive queue through the messagePending API. Typically, an application polls the receive queue, acquiring message buffers as they become available.

The group interface provides timed or indefinitely blocking receive methods, and select and file descriptor set utility methods. Hence, the invention can be quickly integrated with existing applications using standard network programming techniques.

EVT_ERRORED events signal to the group interface that an unrecoverable error has occurred. An EVT_SHUTDOWN event is posted following the observation of an error event. The group interface waits for an EVT_SHUT_COM event. This latter event indicates that the local mechanisms have cleaned up their internal state and the group interface may be destroyed.

An application exits the group via the blocking Quit API call. The Quit call posts an EVT_LEAV_REQ handled by the appropriate mechanisms. The EVT_LEFT_GRP event is used to signal the completion of the member leave. The invention is then deactivated through the shutdown events as described above.

The Policy Engine

Depicted in FIG. 5, the policy engine acts as the central enforcement agent in the invention. All interpretation of policy occurs within the policy engine. This has the advantage of allowing the integration of other policy approaches. For example, a group desiring to enforce the policy defined by a GSAKMP policy token would simply replace the current Ismene policy engine with a GSAKMP policy engine. As is true for Ismene policy instantiations, the token would be distributed by the authentication mechanisms as opaque data. Subsequent enforcement of the policy is relegated to the replacement policy engine.

There are three central tasks of a policy engine: initialization, authentication and access control policy evaluation, and group evolution. The policy engine directs the initialization and configuration of mechanisms upon reconciliation or reception of the policy instantiation. The initiator interprets the provisioning policy by creating a mechanism object for each mechanism defined in the policy instantiation. Mechanisms are configured using the configuration statements in the instantiation immediately following their creation.

Non-initiator participants are faced with a dilemma prior to contacting the group; they do not possess the instantiation with which they can initialize the invention. This is solved by using an instantiation resulting from the self-reconciliation of the local policy (which in Ismene, for any correctly constructed policy, is guaranteed to terminate successfully).

Not all policy languages implement local policies. In this case, some other means of communicating an initial configuration must be found. For example, a simple configuration file can be used to state a local policy.

However, several requirements are placed on this local policy. First, the local policy must specify an authentication mechanism used to contact the group and acquire the instantiation. Secondly, an access control policy stating from whom an instantiation can be accepted must be defined. The instantiation defined by the local policy is used to initialize the set of services used to contact the group. Once the instantiation is received, the member determines its compliance with the local policy. If compliant, the mechanisms and configuration defined by the local policy are discarded, and the invention is re-initialized using the configurations defined in the instantiation.

The enforcement of authentication and access control is performed by the policy engine throughout the session. Each mechanism is cognizant of the actions to be protected by policy (i.e., hard-coded in implementation). For example, a membership mechanism consults the policy engine when a participant attempts to join the group. The policy stating the requirements to gain access to the group (i.e., the conditions and credentials) are stated in the join authentication and access control clauses. The Ismene policy engine performs the Authentication and Access Control Evaluation algorithm (AEVL) defined herein below to arrive at an acceptance decision. How a participant joins the group is largely independent of evaluation. Policy engines implementing other languages behave in essentially the same way, with the exception of the evaluation of conditions and authentication statements. The present invention supports a range of basic actions protected by policy through the current mechanism implementations. However, mechanisms are free to define new protected actions. All policies must acknowledge the existence of the action through the definition of authentication and access control clauses.

Policy evolution occurs when a reconfig consequence (or similar construct in other policy languages) is enacted by the policy engine. reconfig signals to the group some aspect of the group has fundamentally changed, and that this change requires the group re-assess its provisioning and authentication and access control (policy evolution). The group disbands in response to the observation of the reconfig event. At this point, the initiator performs reconciliation (potentially under a new set of local policies), and the group is initialized as before. Initiation of this process is in itself a protected action. Left unprotected, a malicious member of the group may mount a denial of service by continually signaling reconfiguration.

Mechanisms

Policy in the method and system of the present invention is enforced through the software modules called mechanisms. Each mechanism consists of a set of behaviors and associated protocols designed to perform some service within the session. The current mechanisms layer defines six types of mechanisms: authentication, membership, key management, data handling, failure detection and recovery, and debugging.

The mechanisms layer coordinates the construction of mechanisms. Mechanisms are created from a repository of implementations by the mechanism factory as directed by the policy engine. The factory maps unique mechanism identifiers onto an implementation. Once created, the mechanism is configured and attached to the event bus.

This section describes mechanisms for a centralized group. Centralized groups contain a distinct member performing policy distribution and authentication (known throughout as the authentication service), membership management (admittance entity), key distribution (group key controller), and failure detection (failure monitor). For simplicity, the following assumes the initiator is the central entity for all these functions. However, new mechanisms and policies may be introduced to distribute the various centralized functions to one or more members of the group. In the extreme case, such as in participatory key management, all members collaborate to provide a function. The following text describes the requirements, interfaces and operation of mechanisms.

Authentication Mechanisms

Authentication mechanisms provide facilities for potential group members (requesters) to initiate communication with the group. All authentication mechanisms implement protocols performing mutual authentication and acquiring the policy instantiation. This typically requires an authentication and key exchange protocol between the member and an authentication service. The authentication mechanism implements both the requestor (joining member) and service (initiator processing authentication requests) sides of the authentication.

As with any mechanism, the authentication mechanism is created by the policy engine when the application is initialized. The local policy is evaluated to arrive at a set of mechanisms and their configurations. The mechanisms are created by calling the appropriate mechanism constructor functions which are passed the configuration parameters. The newly initialized mechanisms then wait for events.

The requestor initiates an authentication protocol after receiving an EVT_AUTH_REQ event (emitted after completion of the mechanism initialization). How the mechanism proceeds is dependent on its implementation, its configuration, and statements of authentication and access control. Typically, the requestor will initiate an exchange with the authentication service. For example, the Leighton-Micali key exchange protocol was used in the prior art. Alternately, mutual authentication can be established via some external authentication service (e.g., Kerberos). The present invention currently implements three authentication mechanisms: a null authentication mechanism, an OpenSSL based mechanism, and a Kerberos mechanism. The following text and FIGS. 6a and 6b describe the operation of the OpenSSL based authentication mechanism. However, independent of an implementation, the operation of each of these mechanisms is largely similar.

The mechanism is created and initialized as directed by the evaluated local policy (a). Upon reception of the EVT_AUTH_REQ event, the OpenSSL mechanism initiates communication by establishing a mutually authenticated secure channel. The means by which the authentication service is identified is external to the present invention (it is currently implemented by the broadcasting of a locator message to the group). The authentication service responds with an address and port to which the requester may connect (b). However, other implementations are free to use other mechanisms (anycast, expanding ring searches, session announcements, etc.).

The certificate used to prove authenticity of the local entity is explicitly stated in the local policy through a configuration parameter. The associated certificate file is read from the local disk and passed to OpenSSL (c). The SSL implementation performs the handshake protocol, which receives an authenticated public key certificate for the service (d). The certificate is translated into a credential, and provided to the policy engine for evaluation of the group_auth action (e). A positive result signals that the local policy states the certificate is sufficient to prove the authenticity of the authentication service. The authentication request is aborted to a negative result.

If the service authentication is successful, the authentication mechanism obtains the policy instantiation, a join nonce, and a group public key, and to establish a pair-key.

The group public/private key pair is generated by the initiator during initialization of some centralized groups. The private key is later used to guarantee the (source) authenticity of broadcast data (e.g., rekey messages, failure detection messages).

This is accomplished through a single request-response exchange over the OpenSSL connection. The local member creates and transmits a pair key (for a configured algorithm), and the server responds with the nonce, group public key, and policy instantiation (f). The SSL connection is closed, and the local entity places nonce and group public key in the (mechanism) group attribute set. An EVT_POL_RCVD event containing the instantiation is posted to the event controller. The mechanism signals the completion of the authentication process by posing an EVT_AUTH_COM (h) event.

The authentication services performs the server side of the exchange. The member_auth evaluation signals that the client side certificate is sufficient to prove rights to access the instantiation, and the exchange is completed as described. The pair key is placed in the authentication service's attribute set.

A number of error conditions can occur during the authentication process. A retry timer is registered when the authentication mechanism begins initialization (the length of which is defined through a configuration parameter). Any exchange not completing prior to expiration is retried and a retry count incremented. If the (configurable) maximum retry count is reached, a fatal error is generated and the authentication is aborted. Similarly, any denial of a group_auth or member_auth action fatally errors the authentication attempt.

Membership Mechanisms

Membership mechanisms provide facilities for a previously authenticated member to join and leave the group, to request the ejection of other group members, and for the distribution of group membership lists. The prior art implemented these facilities in the Join, Leave, and Rekey/Group Membership mechanisms. However, it was found that the separation of these membership tasks among different mechanisms limited flexibility; modification of membership services required changes across several mechanisms. This conflicted with the component philosophy, and hence led to the new structure. The present invention currently implements a single membership mechanism (the present membership mechanism.).

The membership mechanism implements both client (member joining group) and server (admittance entity) services. The client implementation initiates the join protocol in response to the EVT_JOIN_REQ event posted by the group interface in response to the EVT_AUTH_COM event. The client simultaneously registers a join retry timer and sends a join request message to the admittance entity. The completion of the join is signaled by a key management mechanism through the EVT_NEW_GRUP event, after which all timers are unregistered.

While in general any cryptographic material may be used to prove the authenticity of the joining member, the current implementation uses the pair-key established by the authentication mechanism. Some environments may desire to separate the authentication of members from the join process. Hence, other implementations may require a second authentication protocol to join the group.

The admittance entity, through the policy engine, evaluates the join action upon reception of the join request. If the action is permitted, a join accept message is broadcast to the group, and a join reject otherwise. The admittance entity posts an EVT_JOIN_MEM if the member was not previously in the group, and an EVT_REJN_MEM if the member is currently in the group. The latter event signals that the joining member's state is stale and should be refreshed.

The EVT_REQ_LEAV event signals that the local member desires to leave the group. The membership mechanism broadcasts a member leave message and posts EVT_MEM_LEAV event. As configured by policy, the local member may or may not wait for a leave response before exiting.

EVT_EJCT_REQ events signal that the local entity wishes to eject another member. The event data identifies the member to be ejected. The associated text identifier is placed in the ejection request message broadcast to the group. The ejection is either accepted or denied by the admittance entity, the result being reported in the ejection response message. The positive or negative result of the ejection is reported through the EVT_ECJT_COM event. The admittance entity restricts access to the ejection through the evaluation eject action. Based on configured policy, eject requests may either be encrypted using the pair key or digitally signed. In the latter case, the certificate itself is included with the request. Hence, the right to eject members can be explicitly granted through an issued certificate.

Policy determines when membership lists are distributed. For example, the current membership mechanism supports policies for none, best-effort, positive, negative, or perfect membership. Based on the policy, a sequenced and signed (with the group private key) membership list is distributed following every member leave (EVT_MEM_LEAV and EVT_PRC_FAIL events) (positive), every member join (EVT_JOIN_MEM) (negative), or on all membership events (perfect). In all cases except a none policy, the membership list is broadcast to the group periodically. Members failing to receive membership lists can request the membership list via the membership request message.

Membership lists contain two sequence numbers. The interval identifier states the current interval (which increases by one per configurable quanta). The view identifier sequences the membership changes between intervals. Because the intervals are fixed, the accuracy of membership information is bounded by the configured announcement periodicity (quanta). The current interval and view sequence numbers are reported to a joining member during the join request/response protocol.

Key Management Mechanisms

Key management mechanisms are used to establish and replace the ephemeral keys used to secure the group. While the present invention currently implements a Key Encrypting Key (KEK), Authenticated Group Key Management (AGKM, see below), and Logical Key Hierarchy (LKH) key management mechanisms, others are possible. For example, the current interface can be used to implement participatory key management (e.g., Cliques). The following assumes that the KEK mechanism managing a single symmetric session key is used to secure the group. Key management implements two distinct operations: key distribution and rekey management.

The group key controller (GKC) creates a key encrypting key and a traffic encrypting key (TEK) for the configured cryptographic algorithm upon reception of the EVT_NGRP_POL event. A key distribution message encrypted with the member pair-key and containing the KEK, TEK, and a group identifier is subsequently sent to a joining member in response to the reception of each EVT_JOIN_MEM or EVT_REJN_MEM event. A member receiving the message places the KEK and TEK in the local attribute set and posts an EVT_NEW_GRUP event signaling that the join has been completed.

The group identifier uniquely identifies the session context. A group identifier is the concatenation of a text identifier and nonce value. The text identifier is an eight byte, null terminated name string that uniquely identifies the session. The nonce is a four byte nonce value. The group identifier is used by all mechanisms to identify under which context (e.g., key) a message was sent. The nonce is incremented by one each time the group is rekeyed.

Policy determines when the group is rekeyed. Similar to membership management, the group rekeying is defined over time, leave, join, and membership sensitive policies. These policies indicate that the group is rekeyed periodically, after member leaves, joins, or all membership events, respectively. However, only time sensitive policies are meaningful in KEK based schemes. KEK mechanisms are required to be time-sensitive. Hence, a timer is created with a configured period at initialization. A group rekey message containing a new TEK encrypted with the KEK is distributed following each timer expiration. Clients receiving a group rekey message install the new group identifier and TEK, and post an EVT_NEW_GRUP as described above.

EVT_KDST_DRP events signal that the local member has missed a rekey message. These events are posted by any mechanism receiving a message containing a group identifier for which a corresponding key has not been received. A naive implementation would simply immediately transmit a key request. However, message loss caused by network congestion may be exacerbated by the simultaneous generation of retransmit requests by many members. Known as sender implosion, this problem is likely to limit the efficiency of key distribution in large groups or on lossy networks. A retransmit mechanism similar to SRM addressing this limitation is used. The member sets a random timer before sending a key request message. If another key request is received prior to expiration of the timer, the request is suppressed. The GKC retransmits the last rekey message upon reception of a key request message.

Authenticated Group Key Management

The Authenticated Group Key Management (AGKM) mechanism implements a variant of KEK key management. With respect to the present invention, it processes signals as described above. However, TEKs are calculated rather than distributed. Hence, because any member receiving seeding data can calculate session keys, much of the complexity associated with key management can be avoided.

The following illustrates the AGKM construction wherein members are distributed seed information from which session keys are calculated. Session keys can only be calculated after authenticating information is disclosed by the GKC.

| Configuration Parameters | | Initial Values Generated By the GKC | | Construction | |
|---|---|---|---|---|---|
| l | length of key chain | k₀ | random key seed of size \|h( )\| | vᵢ = h^{l-i}(v₀) | authenticator values |
| h( ) | collision resistant hash function | v₀ | random authenticator seed of size | kₗ = hⁱ(k₀) | key seed values |
| | | g⁺, g⁻ | group public key pair | SKⱼ = h(kᵢ ⊕ vᵢ) | session key |

1. The session keys are used in index order (e.g., SK₀, SK₁, . . . , SKₚ). Hence, the session key SKᵢ is valid only during the interval i, and is replaced periodically through the rekeying process as described herein.

2. A member joining during interval i receives the i, vᵢ, kᵢ, and g⁺. These values are transmitted under a pair key known only to the GKC and the joining member.

3. The group is rekeyed by incrementing i and transmitting i and vᵢ (in cleartext). When the values of vᵢ are exhausted (e.g., i=p), a reseed message is broadcast to the group. The reseed message has the following structure:

$$\{ \overline{{v}_{p}} , {\{ 0 , {k}_{0} , {v}_{0} \}}_{\overline{{k}_{p}}} \} SIG ( {g}^{-} )$$

Where \overline{vₚ} and \overline{kₚ} are the last validator and key seed values from the previous chains, and SIG(g⁻) is a digital signature generated using the group private key g⁻. The new values of k and v are used to seed the new key chain.

4. Any member who does not receive a rekey or reseed value can request it directly from the GCK. However, the GCK will never broadcast past values of k or v (e.g., 0, k₀, and v₀ are replaced with the current interval values—i, kᵢ, and vᵢ). In all cases, the session key is calculated from the header information and known values of v and k.

5. Any vⁱ can be authenticated by evaluating the truth of the expression vᵢ₋₁=h(vⁱ). More generally, any member who has received the key distribution data for some index j<i can validate vᵢ by applying h( ) the appropriate number of times to the initially authenticated (via digital signature) vⱼ.

As described above, AGKM provides a sequence of authenticated session keys preserving the advantages of KEK-based solutions. This approach provides session key independence; knowledge of a session key provides no information with which other session keys can be determined (without inverting h( )). This approach also suffers from some of the disadvantages of KEK-based key management; it is not possible to eject members without replacing all keying material.

AGKM offers several advantages over traditional KEK |h( )| approaches. Every key is authentic; proof of its origin can be obtained from the authenticator values. Moreover, membership forward secrecy is guaranteed only by distributing the most recent seed values to a joining member. Because a malicious member of the group cannot generate validation information for future session keys, new keys can only be released by the group key controller. Hence, a member can only use those keys that have been released.

An alternate use of AGKM places a header containing the current validator information on each transmitted message. Members receiving any message are able to directly calculate the session key. Hence, much of the cost of explicit key distribution is avoided. This approach is useful in large groups (e.g., as one might find in large scale multimedia applications); providing reliability for rekeying information can lead to sender implosion. The cost of this construction is header size; assuming a 16 byte hash function, AGKM requires 18 bytes of header per message.

AGKM is not the first implicit key management approach. The NARKS and MARKS systems use a seeded hierarchy to implement implicit key management for pay-per-view video. However, AGKM's construction is significantly less costly. Receivers in NARKS and MARKS must maintain state that grows logarithmically with the number of session keys supported (as opposed to the constant amount of state required by AGKM).

Data Handling Mechanisms

The data handling mechanism provides facilities for the secure transmission of application level messages. The security guarantees provided by the current data handler mechanism include: confidentiality, integrity, group authenticity, and sender authenticity. The mechanism is configured to provide zero or more of these properties. A data transform is defined for each unique combination of properties.

Upon reception of an EVT_SEND_MSG event, the data handler evaluates the send action via the policy engine. This tests whether the local member has the proper credentials to send a message. If a positive result is returned, the data handler mechanism performs the appropriate transform and broadcasts the data via the broadcast transport layer. Once the message is sent, an EVT_SENT_MSG event is posted to the event queue.

The mechanism receiving the message performs the reverse transform and evaluates the send action (using the context supplied in the message rather than local credentials). If a positive result is returned, an EVT_DAT_RECV event identifying the received data is posted. Note that a received message may require a session key that the local member has not yet received (or never will). In this case, recovery is initiated by the posting of an EVT_KDST_DRP event. The key management mechanism is required to recover by attempting to acquire the key. Messages associated with unknown keys are dropped.

Confidentiality is achieved by encrypting the application data under the session key. The algorithm used for encryption is defined by a policy. The key management and data handling mechanisms must be configured to use compatible cryptographic algorithms. This is stated as a policy requirement in Ismene policies through assertions (as previously described).

Integrity is achieved through Keyed Message Authentication Codes (HMAC). To simplify, an HMAC is generated by XORing a hash of the message with the session key. A receiver determines the validity of an HMAC by decrypting and verifying the hash value. If the hash is correct, the receiver is assured that the message has not been modified in transit by an adversary external to the group. Group authenticity is a byproduct of integrity. Two constructions supporting source authentication are currently available. In either construction, the content is accepted if the message and authenticating information is properly formed and the content_auth action evaluates successfully.

The packet signing source authentication construction implements source authentication through digital signature. The signature is generated using the private key exponent associated with the sender's certificate. Receivers obtain the sender's certificate and verify the signature using the associated public key.

Due to the computational costs of public key cryptography, the use of per-message digital signatures to achieve sender authenticity is infeasible in high throughput groups. Several efforts have identified ways in which these costs may be mitigated. While the speed of these algorithms is often superior to strictly on-line signature solutions, their bandwidth costs make them infeasible in high throughput groups.

The online construction implements source authentication through a custom variant of Gennaro and Rohatgi online signatures. In this approach, outgoing data is buffered for a configurable period. A online digital signature is applied when a configurable threshold of data (called a frame) is buffered or the period expires. The signature performs a forward chaining approach in which a packet signs (contains a hash) of the immediate succeeding packet. The first packet is digitally signed, all data is transmitted to the group. Receivers can validate the first and subsequent packets as they arrive. However, all packets following a lost packet are dropped; the chained signature is broken (however the mechanism is resilient to packet re-ordering). This makes this approach inappropriate for networks with significant packet loss.

Failure Detection and Recovery Mechanisms

Failure detection mechanisms provide facilities for the detection and recovery of process or communication failures. The current chained failure detection (CFD) mechanism detects crash failed processes. However, other mechanisms (e.g., partition detection and recovery) may be integrated through the event interfaces. The remainder of this section assumes a CFD failure detection mechanism.

An application's threat model may require that the system tolerate attacks in which an adversary prevents delivery of rekeying material. Thus, without proper failure detection, members who do not receive the most recent session information will continue to transmit under a defunct session key. Additionally, the accuracy of membership information is in part determined by the ability of the session leader to detect failed processes. Thus, in support of the other guarantees, the goal of CFD is to determine a) which members are operating, and b) that each process has the most recent group state (session keys and group view).

Failure detection in CFD is symmetric. The failure monitor is a centralized service monitoring all current members of the group. Conversely, each member monitors the group via communication with the failure monitor. As dictated by policy, members who are deemed failed are removed from the group. A member detecting the failure of the monitor assumes the group has failed and attempts recovery. If recovery fails, the member notifies the application and errors the communication. Each member and the failure monitor periodically transmit heartbeat messages. CFD detects failed processes through the absence of correct heartbeats. If a policy stated threshold of contiguous heartbeats is not received, the member or monitor is assumed failed. The current group context (e.g., group and view identifiers) is included in each heartbeat. Hence, heartbeats are used to detect when current group state is stale.

The CFD mechanism creates a heartbeat transmission timer during initialization. A heartbeat is transmitted and the timer reset at its expiration. Members associate a timer with the failure monitor after being admitted to the group (e.g., on a EVT_JOIN_COM event). If no valid failure monitor heartbeat is received before the expiration of this timer, the group failure is signaled through the EVT_GROP_LST event.

Upon reception of an EVT_JOIN_MEM, the failure monitor creates a timer for the joining entity (this timer is reset on an EVT_REJN_MEM event). The timer is reset on valid heartbeats received from the member. If the timer expires, then the member is assumed to have failed and an EVT_PRC_FAIL event is posted. Member timers are deactivated on EVT_MEM_LEAV events, and all timers are reset on EVT_NEW_GRUP events.

A member detecting a stale state or lost heartbeat messages can initiate recovery by sending a client recovery message. This message indicates to the session leader that the member requires the most recent group state. The reception of this message triggers an EVT_KDST_DRP event at the failure monitor, which ultimately leads to the re-distribution of the current session state.

Debugging Mechanisms

Debugging mechanisms are used to view the internal state of the group through the observation of events. The currently implemented Scope mechanisms of the present invention logs the progress of the group and records the throughput and latencies characteristics of the application content. Which information is recorded is defined by the policy instantiation. The scope mechanism does not currently post events, but only passively observes events posted to the event bus. As a result, one can debug event processing by analyzing the type, data, and ordering of posted events.

The specialized EVT_INFO_MSG is used by mechanisms to post information to debugging mechanism. This event specifies a single string containing some information of import to the mechanism, and is frequently used to indicate state changes not reported through events.

Broadcast Transport Layer

Multicast services have yet to become globally available. As such, dependence on multicast would likely limit the usefulness of the present invention. Through the broadcast transport layer, the present invention implements a single group communication abstraction supporting environments with varying network resources. Applications identify at run time the level of multicast supported by the network infrastructure. This specification, called a broadcast transport mode, is subsequently used to direct the delivery of group messages. The broadcast transport layer implements three transport modes: symmetric multicast, point-to-point, and asymmetric multicast.

The symmetric multicast mode uses multicast to deliver all messages. Applications using this mode assume complete, bidirectional multicast connectivity between group members. In effect, there is no logical difference between this mode and direct multicast.

The point-to-point transport mode emulates a multicast group using point-to-point communication. All messages intended for the group are unicast to the session leader, and relayed to group members via UDP/IP. As each message is transmitted by the session leader to members independently, bandwidth costs increase linearly with group size. This approach represents a simplified Overlay Network, where broadcast channels are emulated over point-to-point communication. A number of techniques can be used to vastly reduce the costs of this implementation.

Experiences with the deployment of the Secure Distributed Virtual Conferencing (SDVC) application have been previously described. This video-conferencing application is based on the prior art. The deployed system was to securely transmit video and audio of the September 1988 Internet 2 Member Meeting using a symmetric multicast service. The receivers (group members) were distributed at several institutions across the United States. While some of the receivers were able to gain access to the video stream, others were not. It was determined that the network could deliver multicast packets towards the receivers (group members), but multicast traffic in the reverse direction was not consistently available (towards the session leader). The lack of bi-directional connectivity was attributed to limitations of the reverse routing of multicast packets.

The limited availability of bi-directional multicast on the Internet coupled with the costs of point-to-point multicast emulation lead to the introduction of asymmetric multicast. This mode allows for messages emanating from the session leader to be multicast, and all other messages to be relayed through the session leader via unicast. Members unicast each group message directly to the session leader, and the session leader retransmits the message to the group via multicast. Thus, the costs associated with point-to-point group emulation to a unicast followed by a multicast are reduced. The increasing popularity of single source multicast make this a likely candidate for future use.

The transport API requires the application supply the multicast or unicast addressing information appropriate for the environment and transport mode. IP addresses are specified through the creation of encapsulating IPAddress objects. These objects and the enumerated transport mode are passed to the constructor of the transport object constructor, which is ultimately passed to the AGroup object upon its construction. The transport object is not directly accessed after being passed to the AGroup object; all communication with the group is performed through the AGroup object.

Optimizing Policy Enforcement

The architecture described throughout differs significantly from the initial design of the present invention. Several lessons learned from the initial architecture drove the design of the modified present invention. First, the introduction of a formal policy language required fundamental changes in the way in which policy is enforced (e.g., through repeated evaluation of authentication and access control policy). Secondly, any flexible policy infrastructure should provide simple, yet powerful, interfaces for implementing the many required protocols. Finally, care must be taken in designing efficient structures upon which policy is enforced. The following describe several optimizations addressing these design considerations.

Generalized Message Handling

By definition, a flexible policy enforcement architecture must implement a large number of protocols, messages, and data transforms. However, correctly implementing these features requires the careful construction of marshaling code. Marshaling is widely accepted as a difficult, time consuming, and error prone process. This belief was reinforced by difficulties encountered while developing and debugging the first version of the present invention.

The Generalized Message Handling (GMH) service is designed to address the difficulties of protocol development. This service abstracts marshaling by allowing the flexible definition of message formats. GMH uses this information in conjunction with user supplied context to marshal data. Encryption, padding, byte ordering, byte alignment, and buffer allocation and resizing are handled automatically by GMH. Hence, the development costs associated with implementing new protocols are reduced and bugs associated with marshaling are largely eliminated. Message marshaling objects are interpreted (and can be reconfigured) at run-time. This represents a departure from the statically complied marshaling interfaces found in prior art (e.g., CORBA, RPC).

An AMessageDef object defines the structure of a message. Typically, a static AMessageDef object is defined for each message type implemented by a mechanism. For example, the ADataHandler mechanism defines a definition object for each unique combination of data security policies (e.g., confidentiality, integrity, etc.). The central attribute of each message definition object is the msgDef string. This alphanumeric string defines the typed ordering and encapsulation of fields. For example, the following defines a simplified key distribution message:

msgDef=“LTH[H[E[DT]]”

Each alphanumeric character in the definition represents a field (data fields) or operation spanning fields (encapsulation fields). The latter field types identify the scope of operations using bracket symbols. In the above example, the characters L, T, and D represent a long integer (group identifier), string (identity), and data block (key). The symbols H[ . . . ] and E[ . . . ] represent HMAC and encryption operations.

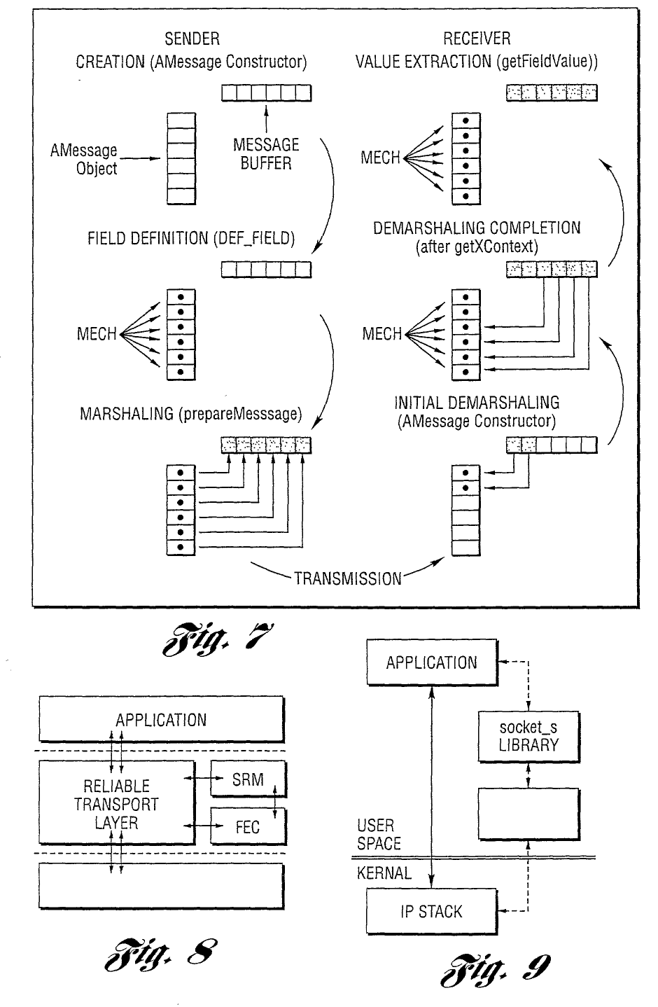

Described in FIG. 7, a message is marshaled in three steps. First an AMessage object is constructed as directed by the associated AMessageDef object. Next, the values for each field are assigned through the type checking DEF_FIELD macro (indexed by field number). Data fields are passed the values to place in the message. Encapsulation fields are passed Key objects (for encryption) or Key and HashFunction objects (for HMACs). Once all field values have been assigned, the prepareMessage( ) method is called to perform the marshaling. The marshaled data is accessed through the MsgBuf access method after the prepareMessage( ) method returns. This buffer is used to transmit the marshaled message to the group.

Upon reception of the message, receivers reverse this process through an AMessage constructor accepting the received buffer. There may not be enough information at the time of reception to completely unmarshal the message. For example, the parent mechanism may not know a priori the key that was used to encrypt a message. Hence, the mechanism must determine the context under which a message was sent. The GMH service unmarshals as much data as is possible, and calls the getEncryptionContext( ) or getHMACContext( ) method on the mechanism object. The mechanism can call getFieldValue( ) on every field that has been unmarshaled within the context method. Fields values are used to determine the appropriate context, and the appropriate keys and algorithms are reported to GMH based on this information. Once the constructor completes, all fields values may be accessed through the getFieldValue( ) method on the message object.

Caching Authentication and Access Control

Authentication and access control policy is consulted on every regulated action. Some actions are undertaken frequently. For example, a video conferencing application may send many packets per second. Thus, evaluating policy prior to the transmission of every packet may negatively affect performance.

The present invention provides a two level cache for authentication and access control. The first level cache stores the result of condition evaluation. The right to perform an action may be predicated on measurable state. The measurement of state is tested using special purpose functions implemented by mechanisms, the group interface, or the application itself through the PolicyImplementor API. This API requires that each condition evaluation return not only the positive or negative evaluation of the condition, but must indicate the period during which the result should be considered valid. There are three indicators associated with the reported period: transient, timed, and invariant. Transient results should be considered valid for only the current evaluation. Timed results explicitly state a discrete period during which the result should be considered valid. Invariant results are considered valid for the lifetime of the session. The cache is consulted during the evaluation of any authentication and access control policy.

A second level cache stores the results of policy evaluation. This cache stores the relevant context under which an action was considered (e.g., credentials and conditions used during evaluation). Entries in the cache are considered valid for the minimum of the reported condition evaluations. Hence, any member testing the same conditions and credentials (as would be the case in frequently undertaken actions) would simply access a cached result. Both caches are flushed following policy evolution.

Applications

This section briefly describes the use of the method and system of the present invention in two applications: a reliable broadcast layer and a secure multicast layer used to augment existing group applications. A number of other applications (such as a streaming media and filesystem mirroring service) have been developed using the present invention.

Reliable Transport Layer

The Reliable Transport Layer (RTL) provides FIFO delivery of application traffic delivered by a group of the present invention. Depicted in FIG. 8, RTL uses a combination of Forward Error Correction (FEC) and the approach used in the Scalable Reliable Multicast (SRM) protocol to detect and recover from lost packets. A mechanism implementing each approach is layered between the application and the invention.

The FEC mechanism uses a modified version of the approach described in the prior art. In the present implementation, FEC produces an additional q redundant packets for each p original packets. All p+q packets are transmitted to the group. Because of the properties of packet construction, all original packets can be recovered from any p packets. However, a receiver encountering q or more losses cannot recover. Where enabled, these failures are repaired using the SRM mechanism.

The SRM mechanism implements the general approach implemented by Scalable Reliable Multicast protocol. Receivers detecting a lost packet broadcast a retransmission request to the group. Sender implosion is avoided by randomly delaying the retransmission request. To simplify, all receivers suppress requests corresponding to previously requested packets. If no such request is observed prior to the expiration of a random interval, the request is broadcast. This approach can effectively provide full reliable data delivery. However, the FEC mechanism can be used to reduce the number of retransmission requests.

Based on policy, an application can select either FEC, SRM, or both. Furthermore, policy can be used to parameterize their operation based on administrative considerations and operating conditions. For example, the FEC mechanism may wish to increase redundancy (e.g., larger values for q) where observed loss rates are high, and decrease redundancy where rates are low. The RTM policy can be specified directly in the group policy of the present invention. TRM probes the invention for the appropriate configuration during its initialization, and appeals to the application for direction where a configuration is not specified.

End-Host Security

The proliferation of group multicast applications (e.g., VIC) has raised awareness of the need for secure multicast services. However, re-architecting applications to take advantage of security services is often difficult. Thus, it is highly desirable to use the end-host (transport)-level services for security. Towards this end, the socket_s library has been developed. Socket_s redirects multicast traffic to a user-space instantiation of the invention. Existing applications can integrate with the invention with only minor source code modification through this library.

Illustrated in FIG. 9, the Socket_s library acts as a “bump in stack” by inserting the invention between the application and the standard network interfaces. Each socket related call in the application is replaced with the appropriate Socket_s call. For example, each bind call is replaced with bind_s. The “_{—s}” calls direct multicast related traffic towards the invention, and non-multicast traffic to the standard library.

Local policies are managed at the host level; configuration and policy files are placed in a well-known directory, and are accessed by Socket_s as needed. Each domain has a known session leader who initiates and maintains groups for each active session occurring within its administrative scope. The identity and location of the session leader is configured at each host.

Users initiate communication with a group of the invention through the Socket_s and setsockopt_s (IGMP join) calls. A background thread created during the Socket_s call receives and sends all specific communication of the invention (Authorization requests, Rekey messages, etc.). The thread establishes a local connection with the parent application. Data received from the group of the invention is directed to the application through the local connection. The parent process receives this data from the local connection as with any normal socket.

The key interfaces to Socket_s include:

socket_s: creates a “socket” endpoint for communication. If the
desired socket is of the type SOCK_DGRAM (UDP), it initializes a
group object of the invention and returns a “socket” filehandle. (Un-
secured) unicast sockets can be treated by accessing the
libc socket call.
bind_s: creates and initializes a Transport object of the invention
using the supplied address and port number.
setsockopt_s: set socket parameters. The following two socket
options are currently supported:

IP_MULTICAST_LOOP - enables/disables local host
multicast loopback
IP_ADD_MEMBERSHIP - joins the group as
described above.

sendto_s: send a message to the multicast group. The host
network address and message data is transmitted using the
sendMessage interface.
recvfrom_s: receive data from multicast group. The local
connection associated with the socket is checked for data. If data is
available, it is retrieved and copied to the (application) local buffer.

All communication directed towards unicast addresses is redirected to the standard libc socket calls. Where needed, other transport layer security services (such as IPSec) can be used to secure unicast communication. However, this has the disadvantage of decoupling all unicast traffic from the policies governing the application. An alternative is to use the invention to create an additional group (containing only two members) for each peer session. However, these two party groups would pay the unnecessary cost of group management. These costs can be mitigated by provisioning the mechanisms of the invention with policies optimized for two member groups.

The method and system of the present invention provide flexible interfaces for the definition and implementation of security policies through the composition and configuration of security mechanisms. The set of services and protocols used to implement the group is developed from a systematic analysis of the properties appropriate for a given session in conjunction with operational conditions and participant requirements. The resulting session defining policy instance is distributed to all group participants and enforced uniformly at each host.

The Application Programmer Interface (API) allows the simple integration of group-based applications with a flexible policy infrastructure. Developers are free to use the available policies and mechanisms, if they are satisfactory for their purposes or build their own using the high-level mechanism API.

The use of the API with two example applications is described above. The reliable group communication system provides an additional layer upon which reliable groups can be built. The host level multicast security application demonstrates how existing applications may be integrated with the invention with only minor modifications.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method for determining and enforcing security policy in a communication session for a group of participants, the method comprising:
providing group and local policies wherein each local policy states a set of local requirements for the session for a participant and the group policy represents a set of conditional, security-relevant requirements to support the session;
generating a policy instance based on the group and local policies wherein the policy instance defines a configuration of security-related services used to implement the session and rules used for authorization and access control of participants to the session;
analyzing the policy instance with respect to a set of correctness principles;
distributing the policy instance to the participants; and
enforcing the security policy based on the rules throughout the session.

2. The method as claimed in claim 1 wherein the step of distributing includes the steps of authorizing a potential participant to participate in the session based on the rules and determining whether the potential participant has a right to view the security policy.

3. The method as claimed in claim 1 wherein the step of analyzing verifies that the policy instance adheres to a set of principles defining legal construction and composition of the security policy.

4. The method as claimed in claim 1 wherein the step of generating includes the step of reconciling the group and local policies to obtain the policy instance which is substantially compliant with each of the local policies and wherein the policy instance identifies relevant requirements of the session and how the relevant requirements are mapped into the configuration.

5. The method as claimed in claim 1 further comprising verifying that the policy instance complies with the set of local requirements stated in the local policies.

6. The method as claimed in claim 5 further comprising identifying parts of a local policy that are not compliant with the policy instance and determining modifications required to make the local policy compliant with the policy instance.

7. The method as claimed in claim 5 further comprising preventing a potential participant from participating in the session if the policy instance does not comply with the set of local requirements of the potential participant.

8. The method as claimed in claim 1 wherein the step of enforcing includes the steps of creating and processing events.

9. The method as claimed in claim 8 wherein the step of enforcing includes delivering the events to security services via a real or software-emulated broadcast bus.

10. The method as claimed in claim 8 wherein the step of creating events includes the step of translating application requests into the events.

11. The method as claimed in claim 8 wherein the step of enforcing further includes the steps of creating and processing timers and messages.

12. The method as claimed in claim 1 wherein the set of local requirements specifies provisioning and access control policies.

13. A system for determining and enforcing security policy in a communication session for a group of participants based on group and local policies wherein each local policy states a set of local requirements for the session for a participant and the group policy represents a set of conditional, security-relevant requirements to support the session, the system comprising:
means for generating a policy instance based on the group and local policies wherein the policy instance defines a configuration of security-related services used to implement the session and rules used for authorization and access control of participants to the session;
means for analyzing the policy instance with respect to a set of correctness principles;
means for distributing the policy instance to the participants; and
means for enforcing the security policy based on the rules throughout the session.

14. The system as claimed in claim 13 wherein the means for distributing includes means for authorizing a potential participant to participate in the session based on the rules and determining whether the potential participant has a right to view the security policy.

15. The system as claimed in claim 13 wherein the means for analyzing verifies that the policy instance adheres to a set of principles defining legal construction and composition of the security policy.

16. The system as claimed in claim 13 wherein the means for generating includes means for reconciling the group and local policies to obtain the policy instance which is substantially compliant with each of the local policies and wherein the policy instance identifies relevant requirements of the session and how the relevant requirements are mapped into the configuration.

17. The system as claimed in claim 13 further comprising means for verifying that the policy instance complies with the set of local requirements stated in the local policies.

18. The system as claimed in claim 17 further comprising means for identifying parts of a local policy that are not compliant with the policy instance and determining modifications required to make the local policy compliant with the policy instance.

19. The system as claimed in claim 17 further comprising means for preventing a potential participant from participating in the session if the policy instance does not comply with the set of local requirements of the potential participant.

20. The system as claimed in claim 13 wherein the means for enforcing includes means for creating and processing events.

21. The system as claimed in claim 20 wherein the means for enforcing includes a real or software-emulated broadcast bus to deliver the events to security services.

22. The system as claimed in claim 20 wherein the means for creating events includes means for translating application requests into the events.

23. The system as claimed in claim 20 wherein the means for enforcing further includes means for creating and processing timers and messages.

24. The system as claimed in claim 13 wherein the set of local requirements specifies provisioning and access control policies.
